(19) United States
(12) Patent Application Publication
(10) Pub. No.: US 2026/0303249 A1
(43) Pub. Date: Oct. 1, 2026

(54) ADJUSTABLE VARIABLE SPLITTERS FOR POWER CONSUMPTION OPTIMIZATION IN PASSIVE OPTICAL NETWORKS

(71) Applicant: Nokia Solutions and Networks Oy, Espoo (FI)

(72) Inventors: Robert Borkowski, Murray Hill, NJ (US); Amitkumar Mahadevan, Edison, NJ (US); Kovendhan Vijayan, Edison, NJ (US); Doutje Van Veen, New Providence, NJ (US); Vincent Houtsma, New Providence, NJ (US)

(21) Appl. No.: 19/092,237

(22) Filed: Mar. 27, 2025

(51) Int. Cl. H04J 14/02; H04Q 11/00

(52) U.S. Cl. CPC H04J 14/0221; H04Q 11/0005; H04Q 11/0067; H04Q 2011/0049

(57) ABSTRACT

Various example embodiments for supporting optical communications in an optical communication system may be configured to support improvement or optimization of power consumption in a passive optical network based on reconfiguration of a variable optical splitter in an optical distribution network of the passive optical network. The improvement or optimization of power consumption based on reconfiguration of the variable optical splitter may be based on determination of a target optical power split setting for the variable optical splitter and reconfiguration of the variable optical splitter to use the target optical power split setting. The reconfiguration of the variable optical splitter to use the target optical power split setting may be based on generation of a sequence of reconfiguration operations for reconfiguration of the variable optical splitter to use the target optical power split setting.

### TECHNICAL FIELD

Various example embodiments relate generally to communication systems and, more particularly but not exclusively, to supporting optical communications in optical communication systems.

### BACKGROUND

Various communications technologies may support various types of communications in various types of communication systems.

### SUMMARY

In at least some example embodiments, an apparatus includes at least one processor and at least one memory storing instructions which, when executed by the at least one processor, cause the apparatus at least to perform obtaining a set of input information associated with a passive optical network including a set of variable optical splitters, and determining, based on the set of input information associated with the passive optical network, a target power split setting for the set of variable optical splitters that is configured to control a power consumption of the passive optical network. In at least some example embodiments, the target power split setting for the set of variable optical splitters is configured to control at least one of a power consumption of a set of transmitters of the passive optical network or a power consumption of a set of receivers of the passive optical network. In at least some example embodiments, the target power split setting for the set of variable optical splitters is configured to control at least one of a power consumption of a set of optical network units of the passive optical network or a power consumption of a set of optical line terminals of the passive optical network. In at least some example embodiments, the target power split setting for the set of variable optical splitters is configured to control a power consumption of a set of optical network units of the passive optical network, wherein the target power split setting is determined based on a metric that is based on optical network unit power consumption at the set of optical network units and signal quality at the set of optical network units. In at least some example embodiments, the target power split setting for the set of variable optical splitters is configured to control a power consumption of a set of optical line terminals of the passive optical network, wherein the target power split setting is determined based on a metric that is based on optical line terminal power consumption at the set of optical line terminals and burst signal quality at the set of optical line terminals. In at least some example embodiments, the target power split setting for the set of variable optical splitters is configured to control a power consumption of an optical line terminal of the passive optical network, wherein the control of the power consumption at the optical line terminal is performed over a set of bursts received at the optical line terminal. In at least some example embodiments, the target power split setting for the set of variable optical splitters is configured to constrain a mean number of forward error correction (FEC) iterations performed by a set of decoders of a set of receivers of the passive optical network such that pre-FEC bit error rate (BER) at the receivers satisfies a set of thresholds configured to constrain the mean number of FEC iterations performed by the set of decoders of the set of receivers to satisfy a target number of FEC iterations. In at least some example embodiments, the target power split setting for the set of variable optical splitters is configured to reduce an amount of power consumed by at least one of a receiver subsystem, a decoder subsystem, an equalization subsystem, a symbol detection subsystem, a chromatic dispersion compensation subsystem, a maximum likelihood sequence estimation subsystem, or a transmitter subsystem. In at least some example embodiments, the input information associated with the set of receivers comprises, for each of one or more receivers in a set of receivers of the passive optical network, at least one of a respective set of channel information for the respective receiver or a respective set of receiver characterization information for the respective receiver. In at least some example embodiments, the respective set of channel information for the respective receiver comprises at least one of: monitoring information configured for use in deriving a bit error rate (BER) value, a received signal strength indicator (RSSI) value, or ranging information indicative of a distance of the receiver from a transmitter serving the receiver, or total forward error correction codewords and/or bytes and/or bits, uncorrected forward error correction codewords and/or bytes and/or bits, corrected forward error correction codewords and/or bytes and/or bits, or codeword error ratio (CWER) and/or byte error ratio and/or bit error ratio (BER) values. In at least some example embodiments, the respective set of receiver characterization information for the respective receiver comprises at least one of an average decoder power of a decoder of the receiver, an average number of iterations to decode as a function of bit error rate, or a reach estimate based on a distance of the receiver from a transmitter serving the receiver. In at least some example embodiments, the set of input information associated with the passive optical network comprises at least one of a range of allowable power split settings, a range of allowable transmitted optical power, a range of allowable received optical power, or a range of allowable optical modulation amplitude. In at least some example embodiments, the set of input information associated with the passive optical network comprises at least one of a set of transmitted optical power levels associated with a set of transmitters of the passive optical network or a set of current received optical power levels associated with a respective set of receivers of the passive optical network. In at least some example embodiments, the set of input information associated with the passive optical network comprises a current power split setting for the set of variable optical splitters. In at least some example embodiments, the target power split setting comprises a vector of numbers which sufficiently characterize the target power split setting for the set of variable optical splitters. In at least some example embodiments, the instructions, when executed by the at least one processor, cause the apparatus at least to perform sending, toward the set of variable optical splitters, the target power split setting for the set of variable optical splitters. In at least some example embodiments, the instructions, when executed by the at least one processor, cause the apparatus at least to perform receiving, at the set of variable optical splitters, the target power split setting for the set of variable optical splitters, determining, at the set of variable optical splitters, a current power split setting for the set of variable optical splitters, generating, at the set of variable optical splitters based on the current power split setting for the set of variable optical splitters and the target power split setting for the set of variable optical splitters, a sequence of reconfiguration operations for reconfiguration of the set of variable optical splitters from the current power split setting to the target power split setting, and converting, at the set of variable optical splitters, the sequence of reconfiguration operations for reconfiguration of the set of variable optical splitters from the current power split setting to the target power split setting into a set of internal splitter settings for reconfiguration of the set of variable optical splitters from the current power split setting to the target power split setting. In at least some example embodiments, the instructions, when executed by the at least one processor, cause the apparatus at least to perform determining a current power split setting for the set of variable optical splitters, generating, based on the current power split setting for the set of variable optical splitters and the target power split setting for the set of variable optical splitters, a sequence of reconfiguration operations for reconfiguration of the set of variable optical splitters from the current power split setting to the target power split setting, and sending, toward the set of variable optical splitters, the sequence of reconfiguration operations for reconfiguration of the set of variable optical splitters from the current power split setting to the target power split setting. In at least some example embodiments, the instructions, when executed by the at least one processor, cause the apparatus at least to perform receiving, at the set of variable optical splitters, the sequence of reconfiguration operations for reconfiguration of the set of variable optical splitters from the current power split setting to the target power split setting, and converting, at the set of variable optical splitters, the sequence of reconfiguration operations for reconfiguration of the set of variable optical splitters from the current power split setting to the target power split setting into a set of internal splitter settings for reconfiguration of the set of variable optical splitters from the current power split setting to the target power split setting.

In at least some example embodiments, a method includes obtaining a set of input information associated with a passive optical network including a set of variable optical splitters, and determining, based on the set of input information associated with the passive optical network, a target power split setting for the set of variable optical splitters that is configured to control a power consumption of the passive optical network. In at least some example embodiments, the target power split setting for the set of variable optical splitters is configured to control at least one of a power consumption of a set of transmitters of the passive optical network or a power consumption of a set of receivers of the passive optical network. In at least some example embodiments, the target power split setting for the set of variable optical splitters is configured to control at least one of a power consumption of a set of optical network units of the passive optical network or a power consumption of a set of optical line terminals of the passive optical network. In at least some example embodiments, the target power split setting for the set of variable optical splitters is configured to control a power consumption of a set of optical network units of the passive optical network, wherein the target power split setting is determined based on a metric that is based on optical network unit power consumption at the set of optical network units and signal quality at the set of optical network units. In at least some example embodiments, the target power split setting for the set of variable optical splitters is configured to control a power consumption of a set of optical line terminals of the passive optical network, wherein the target power split setting is determined based on a metric that is based on optical line terminal power consumption at the set of optical line terminals and burst signal quality at the set of optical line terminals. In at least some example embodiments, the target power split setting for the set of variable optical splitters is configured to control a power consumption of an optical line terminal of the passive optical network, wherein the control of the power consumption at the optical line terminal is performed over a set of bursts received at the optical line terminal. In at least some example embodiments, the target power split setting for the set of variable optical splitters is configured to constrain a mean number of forward error correction (FEC) iterations performed by a set of decoders of a set of receivers of the passive optical network such that pre-FEC bit error rate (BER) at the receivers satisfies a set of thresholds configured to constrain the mean number of FEC iterations performed by the set of decoders of the set of receivers to satisfy a target number of FEC iterations. In at least some example embodiments, the target power split setting for the set of variable optical splitters is configured to reduce an amount of power consumed by at least one of a receiver subsystem, a decoder subsystem, an equalization subsystem, a symbol detection subsystem, a chromatic dispersion compensation subsystem, a maximum likelihood sequence estimation subsystem, or a transmitter subsystem. In at least some example embodiments, the input information associated with the set of receivers comprises, for each of one or more receivers in a set of receivers of the passive optical network, at least one of a respective set of channel information for the respective receiver or a respective set of receiver characterization information for the respective receiver. In at least some example embodiments, the respective set of channel information for the respective receiver comprises at least one of: monitoring information configured for use in deriving a bit error rate (BER) value, a received signal strength indicator (RSSI) value, or ranging information indicative of a distance of the receiver from a transmitter serving the receiver, or total forward error correction codewords and/or bytes and/or bits, uncorrected forward error correction codewords and/or bytes and/or bits, corrected forward error correction codewords and/or bytes and/or bits, or codeword error ratio (CWER) and/or byte error ratio and/or bit error ratio (BER) values. In at least some example embodiments, the respective set of receiver characterization information for the respective receiver comprises at least one of an average decoder power of a decoder of the receiver, an average number of iterations to decode as a function of bit error rate, or a reach estimate based on a distance of the receiver from a transmitter serving the receiver. In at least some example embodiments, the set of input information associated with the passive optical network comprises at least one of a range of allowable power split settings, a range of allowable transmitted optical power, a range of allowable received optical power, or a range of allowable optical modulation amplitude. In at least some example embodiments, the set of input information associated with the passive optical network comprises at least one of a set of transmitted optical power levels associated with a set of transmitters of the passive optical network or a set of current received optical power levels associated with a respective set of receivers of the passive optical network. In at least some example embodiments, the set of input information associated with the passive optical network comprises a current power split setting for the set of variable optical splitters. In at least some example embodiments, the target power split setting comprises a vector of numbers which sufficiently characterize the target power split setting for the set of variable optical splitters. In at least some example embodiments, the method includes sending, toward the set of variable optical splitters, the target power split setting for the set of variable optical splitters. In at least some example embodiments, the method includes receiving, at the set of variable optical splitters, the target power split setting for the set of variable optical splitters, determining, at the set of variable optical splitters, a current power split setting for the set of variable optical splitters, generating, at the set of variable optical splitters based on the current power split setting for the set of variable optical splitters and the target power split setting for the set of variable optical splitters, a sequence of reconfiguration operations for reconfiguration of the set of variable optical splitters from the current power split setting to the target power split setting, and converting, at the set of variable optical splitters, the sequence of reconfiguration operations for reconfiguration of the set of variable optical splitters from the current power split setting to the target power split setting into a set of internal splitter settings for reconfiguration of the set of variable optical splitters from the current power split setting to the target power split setting. In at least some example embodiments, the method includes determining a current power split setting for the set of variable optical splitters, generating, based on the current power split setting for the set of variable optical splitters and the target power split setting for the set of variable optical splitters, a sequence of reconfiguration operations for reconfiguration of the set of variable optical splitters from the current power split setting to the target power split setting, and sending, toward the set of variable optical splitters, the sequence of reconfiguration operations for reconfiguration of the set of variable optical splitters from the current power split setting to the target power split setting. In at least some example embodiments, the method includes receiving, at the set of variable optical splitters, the sequence of reconfiguration operations for reconfiguration of the set of variable optical splitters from the current power split setting to the target power split setting, and converting, at the set of variable optical splitters, the sequence of reconfiguration operations for reconfiguration of the set of variable optical splitters from the current power split setting to the target power split setting into a set of internal splitter settings for reconfiguration of the set of variable optical splitters from the current power split setting to the target power split setting.

In at least some example embodiments, a computer-readable storage medium stores computer program instructions which, when executed by an apparatus, cause the apparatus at least to perform obtaining a set of input information associated with a passive optical network including a set of variable optical splitters, and determining, based on the set of input information associated with the passive optical network, a target power split setting for the set of variable optical splitters that is configured to control a power consumption of the passive optical network. In at least some example embodiments, the target power split setting for the set of variable optical splitters is configured to control at least one of a power consumption of a set of transmitters of the passive optical network or a power consumption of a set of receivers of the passive optical network. In at least some example embodiments, the target power split setting for the set of variable optical splitters is configured to control at least one of a power consumption of a set of optical network units of the passive optical network or a power consumption of a set of optical line terminals of the passive optical network. In at least some example embodiments, the target power split setting for the set of variable optical splitters is configured to control a power consumption of a set of optical network units of the passive optical network, wherein the target power split setting is determined based on a metric that is based on optical network unit power consumption at the set of optical network units and signal quality at the set of optical network units. In at least some example embodiments, the target power split setting for the set of variable optical splitters is configured to control a power consumption of a set of optical line terminals of the passive optical network, wherein the target power split setting is determined based on a metric that is based on optical line terminal power consumption at the set of optical line terminals and burst signal quality at the set of optical line terminals. In at least some example embodiments, the target power split setting for the set of variable optical splitters is configured to control a power consumption of an optical line terminal of the passive optical network, wherein the control of the power consumption at the optical line terminal is performed over a set of bursts received at the optical line terminal. In at least some example embodiments, the target power split setting for the set of variable optical splitters is configured to constrain a mean number of forward error correction (FEC) iterations performed by a set of decoders of a set of receivers of the passive optical network such that pre-FEC bit error rate (BER) at the receivers satisfies a set of thresholds configured to constrain the mean number of FEC iterations performed by the set of decoders of the set of receivers to satisfy a target number of FEC iterations. In at least some example embodiments, the target power split setting for the set of variable optical splitters is configured to reduce an amount of power consumed by at least one of a receiver subsystem, a decoder subsystem, an equalization subsystem, a symbol detection subsystem, a chromatic dispersion compensation subsystem, a maximum likelihood sequence estimation subsystem, or a transmitter subsystem. In at least some example embodiments, the input information associated with the set of receivers comprises, for each of one or more receivers in a set of receivers of the passive optical network, at least one of a respective set of channel information for the respective receiver or a respective set of receiver characterization information for the respective receiver. In at least some example embodiments, the respective set of channel information for the respective receiver comprises at least one of: monitoring information configured for use in deriving a bit error rate (BER) value, a received signal strength indicator (RSSI) value, or ranging information indicative of a distance of the receiver from a transmitter serving the receiver, or total forward error correction codewords and/or bytes and/or bits, uncorrected forward error correction codewords and/or bytes and/or bits, corrected forward error correction codewords and/or bytes and/or bits, or codeword error ratio (CWER) and/or byte error ratio and/or bit error ratio (BER) values. In at least some example embodiments, the respective set of receiver characterization information for the respective receiver comprises at least one of an average decoder power of a decoder of the receiver, an average number of iterations to decode as a function of bit error rate, or a reach estimate based on a distance of the receiver from a transmitter serving the receiver. In at least some example embodiments, the set of input information associated with the passive optical network comprises at least one of a range of allowable power split settings, a range of allowable transmitted optical power, a range of allowable received optical power, or a range of allowable optical modulation amplitude. In at least some example embodiments, the set of input information associated with the passive optical network comprises at least one of a set of transmitted optical power levels associated with a set of transmitters of the passive optical network or a set of current received optical power levels associated with a respective set of receivers of the passive optical network. In at least some example embodiments, the set of input information associated with the passive optical network comprises a current power split setting for the set of variable optical splitters. In at least some example embodiments, the target power split setting comprises a vector of numbers which sufficiently characterize the target power split setting for the set of variable optical splitters. In at least some example embodiments, the computer program instructions, when executed by the apparatus, cause the apparatus at least to perform sending, toward the set of variable optical splitters, the target power split setting for the set of variable optical splitters. In at least some example embodiments, the computer program instructions, when executed by the apparatus, cause the apparatus at least to perform receiving, at the set of variable optical splitters, the target power split setting for the set of variable optical splitters, determining, at the set of variable optical splitters, a current power split setting for the set of variable optical splitters, generating, at the set of variable optical splitters based on the current power split setting for the set of variable optical splitters and the target power split setting for the set of variable optical splitters, a sequence of reconfiguration operations for reconfiguration of the set of variable optical splitters from the current power split setting to the target power split setting, and converting, at the set of variable optical splitters, the sequence of reconfiguration operations for reconfiguration of the set of variable optical splitters from the current power split setting to the target power split setting into a set of internal splitter settings for reconfiguration of the set of variable optical splitters from the current power split setting to the target power split setting. In at least some example embodiments, the computer program instructions, when executed by the apparatus, cause the apparatus at least to perform determining a current power split setting for the set of variable optical splitters, generating, based on the current power split setting for the set of variable optical splitters and the target power split setting for the set of variable optical splitters, a sequence of reconfiguration operations for reconfiguration of the set of variable optical splitters from the current power split setting to the target power split setting, and sending, toward the set of variable optical splitters, the sequence of reconfiguration operations for reconfiguration of the set of variable optical splitters from the current power split setting to the target power split setting. In at least some example embodiments, the computer program instructions, when executed by the apparatus, cause the apparatus at least to perform receiving, at the set of variable optical splitters, the sequence of reconfiguration operations for reconfiguration of the set of variable optical splitters from the current power split setting to the target power split setting, and converting, at the set of variable optical splitters, the sequence of reconfiguration operations for reconfiguration of the set of variable optical splitters from the current power split setting to the target power split setting into a set of internal splitter settings for reconfiguration of the set of variable optical splitters from the current power split setting to the target power split setting.

In at least some example embodiments, an apparatus includes means for obtaining a set of input information associated with a passive optical network including a set of variable optical splitters, and means for determining, based on the set of input information associated with the passive optical network, a target power split setting for the set of variable optical splitters that is configured to control a power consumption of the passive optical network. In at least some example embodiments, the target power split setting for the set of variable optical splitters is configured to control at least one of a power consumption of a set of transmitters of the passive optical network or a power consumption of a set of receivers of the passive optical network. In at least some example embodiments, the target power split setting for the set of variable optical splitters is configured to control at least one of a power consumption of a set of optical network units of the passive optical network or a power consumption of a set of optical line terminals of the passive optical network. In at least some example embodiments, the target power split setting for the set of variable optical splitters is configured to control a power consumption of a set of optical network units of the passive optical network, wherein the target power split setting is determined based on a metric that is based on optical network unit power consumption at the set of optical network units and signal quality at the set of optical network units. In at least some example embodiments, the target power split setting for the set of variable optical splitters is configured to control a power consumption of a set of optical line terminals of the passive optical network, wherein the target power split setting is determined based on a metric that is based on optical line terminal power consumption at the set of optical line terminals and burst signal quality at the set of optical line terminals. In at least some example embodiments, the target power split setting for the set of variable optical splitters is configured to control a power consumption of an optical line terminal of the passive optical network, wherein the control of the power consumption at the optical line terminal is performed over a set of bursts received at the optical line terminal. In at least some example embodiments, the target power split setting for the set of variable optical splitters is configured to constrain a mean number of forward error correction (FEC) iterations performed by a set of decoders of a set of receivers of the passive optical network such that pre-FEC bit error rate (BER) at the receivers satisfies a set of thresholds configured to constrain the mean number of FEC iterations performed by the set of decoders of the set of receivers to satisfy a target number of FEC iterations. In at least some example embodiments, the target power split setting for the set of variable optical splitters is configured to reduce an amount of power consumed by at least one of a receiver subsystem, a decoder subsystem, an equalization subsystem, a symbol detection subsystem, a chromatic dispersion compensation subsystem, a maximum likelihood sequence estimation subsystem, or a transmitter subsystem. In at least some example embodiments, the input information associated with the set of receivers comprises, for each of one or more receivers in a set of receivers of the passive optical network, at least one of a respective set of channel information for the respective receiver or a respective set of receiver characterization information for the respective receiver. In at least some example embodiments, the respective set of channel information for the respective receiver comprises at least one of: monitoring information configured for use in deriving a bit error rate (BER) value, a received signal strength indicator (RSSI) value, or ranging information indicative of a distance of the receiver from a transmitter serving the receiver, or total forward error correction codewords and/or bytes and/or bits, uncorrected forward error correction codewords and/or bytes and/or bits, corrected forward error correction codewords and/or bytes and/or bits, or codeword error ratio (CWER) and/or byte error ratio and/or bit error ratio (BER) values. In at least some example embodiments, the respective set of receiver characterization information for the respective receiver comprises at least one of an average decoder power of a decoder of the receiver, an average number of iterations to decode as a function of bit error rate, or a reach estimate based on a distance of the receiver from a transmitter serving the receiver. In at least some example embodiments, the set of input information associated with the passive optical network comprises at least one of a range of allowable power split settings, a range of allowable transmitted optical power, a range of allowable received optical power, or a range of allowable optical modulation amplitude. In at least some example embodiments, the set of input information associated with the passive optical network comprises at least one of a set of transmitted optical power levels associated with a set of transmitters of the passive optical network or a set of current received optical power levels associated with a respective set of receivers of the passive optical network. In at least some example embodiments, the set of input information associated with the passive optical network comprises a current power split setting for the set of variable optical splitters. In at least some example embodiments, the target power split setting comprises a vector of numbers which sufficiently characterize the target power split setting for the set of variable optical splitters. In at least some example embodiments, the apparatus includes means for sending, toward the set of variable optical splitters, the target power split setting for the set of variable optical splitters. In at least some example embodiments, the apparatus includes means for receiving, at the set of variable optical splitters, the target power split setting for the set of variable optical splitters, means for determining, at the set of variable optical splitters, a current power split setting for the set of variable optical splitters, means for generating, at the set of variable optical splitters based on the current power split setting for the set of variable optical splitters and the target power split setting for the set of variable optical splitters, a sequence of reconfiguration operations for reconfiguration of the set of variable optical splitters from the current power split setting to the target power split setting, and means for converting, at the set of variable optical splitters, the sequence of reconfiguration operations for reconfiguration of the set of variable optical splitters from the current power split setting to the target power split setting into a set of internal splitter settings for reconfiguration of the set of variable optical splitters from the current power split setting to the target power split setting. In at least some example embodiments, the apparatus includes means for determining a current power split setting for the set of variable optical splitters, means for generating, based on the current power split setting for the set of variable optical splitters and the target power split setting for the set of variable optical splitters, a sequence of reconfiguration operations for reconfiguration of the set of variable optical splitters from the current power split setting to the target power split setting, and means for sending, toward the set of variable optical splitters, the sequence of reconfiguration operations for reconfiguration of the set of variable optical splitters from the current power split setting to the target power split setting. In at least some example embodiments, the apparatus includes means for receiving, at the set of variable optical splitters, the sequence of reconfiguration operations for reconfiguration of the set of variable optical splitters from the current power split setting to the target power split setting, and means for converting, at the set of variable optical splitters, the sequence of reconfiguration operations for reconfiguration of the set of variable optical splitters from the current power split setting to the target power split setting into a set of internal splitter settings for reconfiguration of the set of variable optical splitters from the current power split setting to the target power split setting.

In at least some example embodiments, an apparatus includes at least one processor and at least one memory storing instructions which, when executed by the at least one processor, cause the apparatus at least to perform determining, for a variable optical splitter, a current power split setting and a target power split setting, and generating, based on the current power split setting and the target power split setting, a sequence of reconfiguration operations for reconfiguration of the variable optical splitter from the current power split setting to the target power split setting. In at least some example embodiments, a method includes determining, for a variable optical splitter, a current power split setting and a target power split setting, and generating, based on the current power split setting and the target power split setting, a sequence of reconfiguration operations for reconfiguration of the variable optical splitter from the current power split setting to the target power split setting. In at least some example embodiments, a computer-readable storage medium stores computer program instructions which, when executed by an apparatus, cause the apparatus at least to perform determining, for a variable optical splitter, a current power split setting and a target power split setting, and generating, based on the current power split setting and the target power split setting, a sequence of reconfiguration operations for reconfiguration of the variable optical splitter from the current power split setting to the target power split setting. In at least some example embodiments, an apparatus includes means for determining, for a variable optical splitter, a current power split setting and a target power split setting, and means for generating, based on the current power split setting and the target power split setting, a sequence of reconfiguration operations for reconfiguration of the variable optical splitter from the current power split setting to the target power split setting. In at least some example embodiments, the sequence of reconfiguration operations for reconfiguration of the variable optical splitter from the current power split setting to the target power split setting is generated at a controller and provided to the variable optical splitter, and the variable optical splitter receives the sequence of reconfiguration operations for reconfiguration of the variable optical splitter from the current power split setting to the target power split setting and converts the sequence of reconfiguration operations for reconfiguration of the variable optical splitter from the current power split setting to the target power split setting into a set of internal splitter settings for reconfiguration of the variable optical splitter from the current power split setting to the target power split setting. In at least some example embodiments, the sequence of reconfiguration operations for reconfiguration of the variable optical splitter from the current power split setting to the target power split setting is generated at the variable optical splitter and the variable optical splitter converts the sequence of reconfiguration operations for reconfiguration of the variable optical splitter from the current power split setting to the target power split setting into a set of internal splitter settings for reconfiguration of the variable optical splitter from the current power split setting to the target power split setting.

### BRIEF DESCRIPTION OF THE DRAWINGS

The teachings herein can be readily understood by considering the following detailed description in conjunction with the accompanying drawings, in which:

FIG. 1 depicts an example embodiment of a passive optical network (PON) including an optical distribution network (ODN) including a variable optical splitter configured to support optimization of power consumption for communications between an optical line terminal (OLT) and a set of optical network units (ONUs);

FIG. 2 depicts an example embodiment of a PON including a flexible ODN including adjustable variable splitters (AVSs) which may be configured to utilize an optical power split ratio for optimization of power consumption for communications between the OLT and the ONUs of the PON;

FIG. 3 depicts an example embodiment of a method for determining a target optical power split setting, such as a target optical power split ratio, for a set of variable optical splitters;

FIG. 4 depicts an example of a flexible ODN including a set of cascading 1:2 AVSs configured to serve a set of ONUs;

FIGS. 5A-5C depict an example of a scenario in which arbitrary or uncoordinated updates to the optical power split factors of the AVSs of the flexible ODN of FIG. 4 result in a glitch at one of the ONUs served by the set of cascading 1:2 AVSs;

FIG. 6 depicts an example of a system including a flexible ODN including a set of cascading 1:2 AVSs configured to serve a set of ONUs and a splitter controller configured to support reconfiguration of the optical power split factors of the AVSs based on a target optical power split ratio for the AVSs;

FIG. 7 depicts an example embodiment of a method for reconfiguring a set of AVSs, based on a target optical power split ratio for the set of AVSs, in a manner for setting the optical power split factors of the set of AVSs to support the target optical power split ratio;

FIGS. 8A-8C depict an example of a scenario in which intelligent updates to the split factors of the AVSs of the flexible ODN of FIG. 6 prevent glitches in any of the ONUs served by the set of cascading 1:2 AVSs;

FIG. 9 depicts an example embodiment of a method for reconfiguring a variable optical splitter to use a target optical power split ratio;

FIG. 10 depicts an example embodiment of a PON configured to support determination of a target optical power split ratio for a variable optical splitter and reconfiguration of the variable optical splitter to use the target optical power split ratio; and

FIG. 11 depicts an example embodiment of a computer suitable for use in performing various functions presented herein.

To facilitate understanding, identical reference numerals have been used herein, wherever possible, in order to designate identical elements that are common among the various figures.

### DETAILED DESCRIPTION

Various example embodiments for supporting optical communications in an optical communication system are presented. Various example embodiments for supporting optical communications in an optical communication system may be configured to support improvement or optimization of one or more metrics (e.g., power consumption, number of error correction iterations performed, or the like, as well as various combinations thereof) in a passive optical network (PON) including an optical line terminal (OLT), an optical distribution network (ODN), and a set of optical network units (ONUs). Various example embodiments for supporting optical communications in an optical communication system may be configured to support improvement or optimization of one or more metrics in a PON based on configuration of a variable optical splitter(s) in the ODN of the PON. Various example embodiments for supporting optical communications in an optical communication system may be configured to support improvement or optimization of one or more metrics in a PON, based on configuration of a variable optical splitter(s) in the ODN of the PON, in a manner for improving or optimizing one or more metrics associated with operation of the OLT(s) and/or the ONUs in the downstream direction from the OLT to the ONUs (e.g., reducing or optimizing power consumption of the ONUs in performing low-density parity-check (LDPC) forward error correction (FEC) operations within the context of decoding, reducing or optimizing a number of FEC iterations performed by the ONUs, or the like, as well as various combinations thereof), in a manner for improving or optimizing one or more metrics associated with operation of the ONUs and/or the OLT(s) in the upstream direction from the ONUs to the OLT(s) (e.g., reducing or optimizing power consumption of the OLT(s) in performing LDPC FEC operations within the context of decoding, reducing or optimizing a number of FEC iterations performed by the OLT(s), or the like, as well as various combinations thereof), or a combination thereof. It will be appreciated that, although primarily presented herein within the context of example embodiments for reducing or optimizing power consumption of the ONUs in the downstream direction from the OLT(s) to the ONUs, various example embodiments presented herein may be configured to also or alternatively improve or optimize various other metrics, in either or both directions of communication within the PON, based on configuration of a variable optical splitter(s) in the ODN of the PON.

Various example embodiments for supporting optical communications in an optical communication system may be configured to support reduction or optimization of power consumption in a PON based on configuration of a variable optical splitter in the ODN of the PON. The reduction or optimization of power consumption in a PON, based on configuration of a variable optical splitter in the ODN of the PON, may be performed in a manner for reducing or optimizing power consumption of the ONUs in the downstream direction from the OLT to the ONUs (e.g., reducing or optimizing power consumption of the ONUs in performing LDPC FEC operations within the context of decoding), reducing or optimizing power consumption of the OLT(s) in the upstream direction from the ONUs to the OLT(s) (e.g., reducing or optimizing power consumption of the OLT(s) in performing LDPC FEC operations within the context of decoding upstream bursts from the ONUs), or a combination thereof. The reduction or optimization of power consumption based on reconfiguration of the variable optical splitter may be based on determination of a target optical power split setting for the variable optical splitter and reconfiguration of the variable optical splitter to use the target optical power split setting, where the target optical power split setting for the variable optical splitter may be a target optical power split ratio for the variable optical splitter for use by the variable optical splitter for supporting communications between the OLT and the ONUs and/or any other target optical power split setting which may be utilized by the variable optical splitter to support communications between the OLT and the ONUs.

Various example embodiments for supporting optical communications in an optical communication system may be configured to support reduction or optimization of power consumption in a PON based on determination of a target optical power split setting for the variable optical splitter. The determination of the target optical power split setting for the variable optical splitter may be based on various types of input information associated with the PON (e.g., ONU channel information, ONU receiver characterization information, or the like, as well as various combinations thereof). The reduction or optimization of power consumption based on reconfiguration of the variable optical splitter to use the target optical power split setting for communications in the downstream direction from the OLT to the ONUs may be configured to redirect excess optical power incident on one or more of the ONUs having relatively good channel quality to one or more of the ONUs having relatively bad channel quality such that the overall operation of the ONUs is improved while the overall power consumption of the ONUs is reduced or minimized. The optimization of power consumption based on reconfiguration of the variable optical splitter to use the target optical power split setting for communications in the upstream direction from the ONUs to the OLT may be configured to redirect optical power between one or more of the ONUs having relatively good channel quality and one or more of the ONUs having relatively bad channel quality such that the overall operation of the ONUs is improved while the overall power consumption of the OLTs is reduced or minimized.

Various example embodiments for supporting optical communications in an optical communication system may be configured to support reduction or optimization of power consumption in a PON based on reconfiguration of a variable optical splitter to use a target optical power split setting for the variable optical splitter. The reconfiguration of the variable optical splitter to use the target optical power split setting may be based on generation of a sequence of reconfiguration operations for reconfiguration of the variable optical splitter to use the target optical power split setting, such that the sequence of reconfiguration operations for reconfiguration of the variable optical splitter may be applied to the reconfigurable optical splitter for reconfiguring the variable optical splitter from the current optical power setting to the target optical power split setting (e.g., from the current optical power split ratio to the target optical power split ratio). The reconfiguration of the variable optical splitter to use the target optical power split setting may be based on generation of a sequence of reconfiguration operations for reconfiguration of the variable optical splitter to the target optical power split setting, such that the sequence of reconfiguration operations for reconfiguration of the variable optical splitter may be applied to the reconfigurable optical splitter for reconfiguring the variable optical splitter from the current optical power setting to the target optical power split setting, in a coordinated manner over time to ensure hitless (e.g., impact-free) operation of the PON as the reconfiguration of the variable optical splitter from the current optical power setting to the target optical power split setting is performed (e.g. no optical connection is compromised (stops working) or has to reinitialize due to the dynamics of the reconfiguration).

It will be appreciated that, although primarily presented herein within the context of either supporting improvement or optimization of power consumption in the downstream direction from the OLTs toward the ONUs or supporting improvement or optimization of power consumption in the upstream direction from the ONUs toward the OLTs, in at least some example embodiments support for improvement or optimization of power consumption in the downstream direction from the OLTs toward the ONUs and support for improvement or optimization of power consumption in the upstream direction from the ONUs toward the OLTs may be performed jointly. While channel quality in the downstream and upstream directions may have significant correlation, there can be differences due to various factors (e.g., use of different wavelengths, use of different transmitters and receivers, or the like, as well as various combinations thereof). Thus, in at least some example embodiments, the determination of the target power split setting for the variable optical splitter and the associated reconfiguration of the variable optical splitter to use the target power split setting may be performed while considering downstream and upstream jointly.

It will be appreciated that the various example embodiments presented herein, although primarily presented herein within the context of reducing or optimizing power consumption in the downstream direction, alternatively or also may be applied for reducing or optimizing power consumption in the upstream direction or jointly in the upstream and downstream directions.

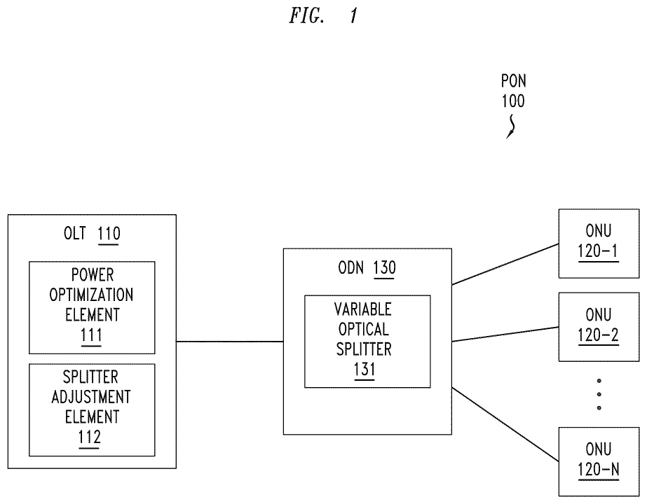

It will be appreciated that these example embodiments as well as various other example embodiments may be further understood by way of reference to FIG. 1, which illustrates an example embodiment of a PON configured to support optimization of power consumption in the PON based on reconfiguration of a variable optical splitter in the ODN of the PON.

FIG. 1 depicts an example embodiment of a passive optical network (PON) including an optical distribution network (ODN) including a variable optical splitter configured to support optimization of power consumption for communications between an optical line terminal (OLT) and a set of optical network units (ONUs).

The PON 100 may be configured to provide network access to a set of customers, based on optical communications, in various contexts and based on various technologies. For example, the PON 100 may operate as a point-to-multipoint (P2MP) data distribution system configured to provide broadband network access over “the last mile” for customers (e.g., the final portion of a telecommunications network that supports communications for customers, including delivering communications to the customers and supporting communications from the customers). For example, the PON 100 may operate using various types of PON technologies and various PON standards (e.g., the G.9804 standard for 50G PON or various other PON standards). It will be appreciated that the PON 100 may be used in various other contexts, configured based on various other PON technologies and/or PON standards, or the like, as well as various combinations thereof.

The PON 100 may include various communication elements configured to support optical communications. The PON 100 includes an optical line terminal (OLT) 110 and a set of optical network units (ONUs) 120-1-120-N (collectively, ONUs 120) connected via an optical distribution network (ODN) 130. The PON 100 may be configured to support downstream (DS) communications from the OLT 110 to the ONUs 120 via the ODN 130 and upstream (US) communications from the ONUs 120 to the OLT 110 via the ODN 130. The PON 100, as discussed further below, may be configured to support DS communications from the OLT 110 to the ONUs 120 based on intelligent configuration and reconfiguration of variable optical splitters within the ODN 130 in a manner that enables optimization of power consumption of the ONUs 120 for the DS communications from the OLT 110 to the ONUs 120. It will be appreciated that the PON 100 may include various other elements (which have been omitted for purposes of clarity).

The OLT 110 is configured to support communications between the ONUs 120 and one or more upstream networks (omitted for purposes of clarity). The OLT 110 may be located in a central location, such as a central office (CO) or other suitable location. For example, the one or more upstream networks may include one or more core communication networks configured to support communications of the OLT 110 and, thus, of the ONUs 120. For example, the one or more upstream networks may include the Internet, data center networks, enterprise networks, or the like, as well as various combinations thereof. For example, the OLT 110 may be configured to forward data received from the one or more upstream networks downstream toward the ONUs 120 via the ODN 130 and to forward data received from the ONUs 120 via the ODN 130 upstream toward the one or more upstream networks. It will be appreciated that the OLT 110 may include various other elements configured to support optical communications within the PON 100.

The ONUs 120 each are configured to support communications between the OLT 110 and one or more downstream networks or devices (omitted for purposes of clarity). The ONUs 120 may be located at respective user premises or other suitable locations. For example, the one or more downstream networks or devices for an ONU 120 may include one or more local area networks (LANs) of the customer, one or more communication devices of the customer (e.g., a modem, a router, a switch, a set top box, a smart television, a gaming system, a computer, a smartphone, or the like, as well as various combinations thereof). For example, an ONU 120 may be configured to forward data received from the OLT 110 via the ODN 130 downstream toward one or more downstream networks or devices and to forward data received from the one or more downstream networks or devices upstream toward the OLT 110 via the ODN 130. It will be appreciated that the ONUs 120 may include various other elements configured to support optical communications within the PON 100.

The ODN 130 may be a data distribution system configured to support communications between the OLT 110 and the ONUs 120, including DS communications from the OLT 110 to the ONUs 120 and US communications from the ONUs 120 to the OLT 110. The ODN 130 is configured to support propagation of optical signals downstream from the OLT 110 to the ONUs 120 and upstream from the ONUs 120 to the OLT 110. The ODN 130 may be implemented using a branching configuration or other suitable P2MP configurations. The ODN 130 may include various passive optical components (e.g., optical fibers, optical couplers, optical splitters, and the like) which do not require power to distribute data signals between the OLT 110 and the ONUs 120. As illustrated in FIG. 1, the ODN 130 includes a variable optical splitter 131 which is controllable to optimize power consumption of the ONUs 120 for DS communications from the OLT 110 to the ONUs 120. It will be appreciated that, although a single variable optical splitter 131 is depicted for purposes of clarity, multiple variable optical splitters may be used within the ODN 130. It will be appreciated that the ODN 130 may include various other elements for supporting communications between the OLT 110 and the ONUs 120.

The PON 100 is configured to support power optimization based on reconfiguration of the ODN 130 to support a target optical power split ratio that facilitates optimization of power consumption by the ONUs 120 in receiving communications from the OLT 110 via the ODN 130. The PON 100 may be configured to support power optimization based on reconfiguration of the variable optical splitter 131 to use the target optical power split ratio to support redirection of excess optical power incident on one or more of the ONUs 120 having relatively good channel quality to one or more of the ONUs 120 having relatively bad channel quality such that the overall operation of the ONUs 120 is improved while the overall power consumption of the ONUs 120 is reduced or minimized. The OLT 110 includes a power optimization element 111 that is configured to determine a target optical power split ratio for the variable optical splitter 131 and a splitter adjustment element 112 that is configured to support reconfiguration of the variable optical splitter 131 to use the target power split ratio for communications from the OLT 110 to the ONUs 120 via the ODN 130. It will be appreciated that the PON 100 may be configured to support various other functions for supporting power optimization within the PON 100.

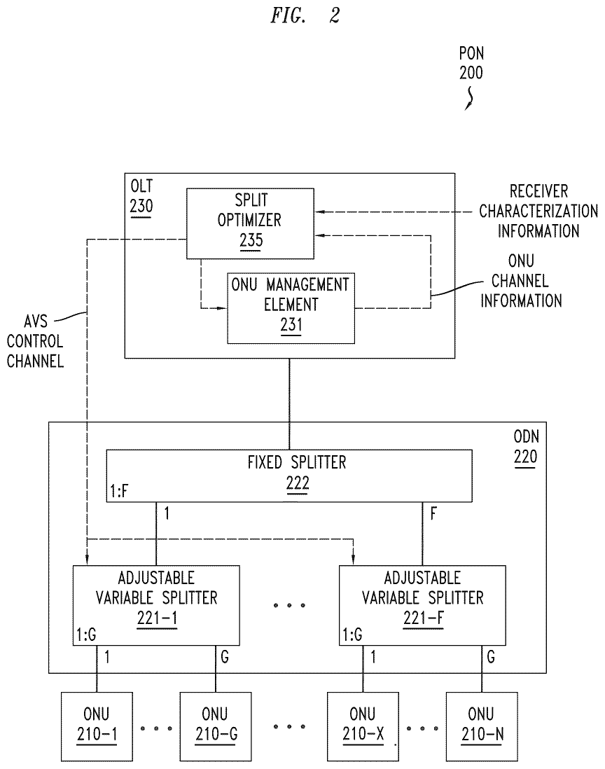

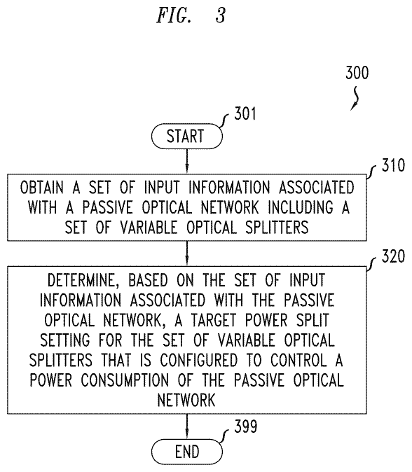

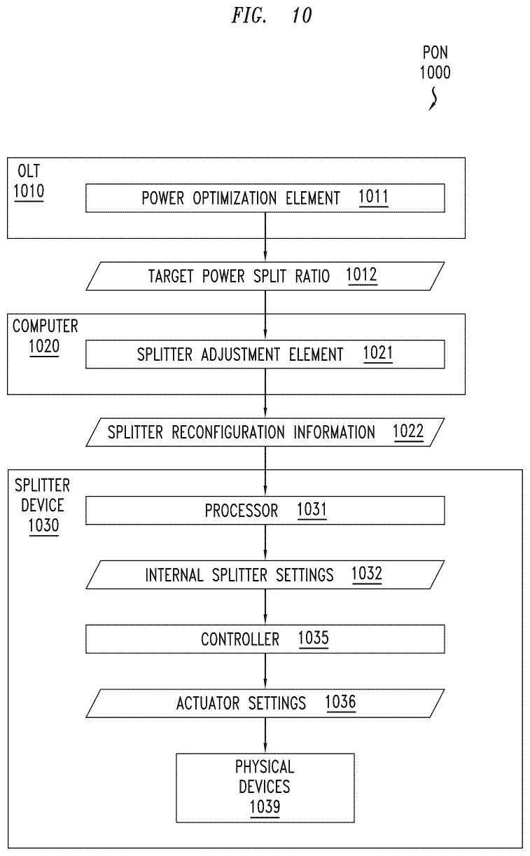

The power optimization element 111, as indicated above, is configured to determine a target optical power split ratio for the variable optical splitter 131. The power optimization element 111 may be configured to obtain a set of input information associated with the PON 100 (e.g., input information associated with the OLT 110, input information associated with the ONUs 120, input information associated with the ODN 130, or the like, as well as various combinations thereof) and determine, based on the set of input information associated with the PON 100, a target power split setting for the set of variable optical splitter 131 that is configured to control a power consumption of the PON 100. It will be appreciated that, although primarily presented with respect to example embodiments in which the power optimization element 111 determines a specific type of optical power setting (namely, a target optical power split setting such as a target optical power split ratio), the power optimization element 111 may be configured to determine various other types of optical power settings. It will be appreciated that, although primarily presented as being disposed within the OLT 110, the power optimization element 111 may be disposed in any other suitable location (e.g., as a standalone system within or associated with the PON 100, on a computer configured to be connected to the variable optical splitter 131 or otherwise communicatively interfaced with one or more elements of the PON 100, or the like, as well as various combinations thereof). It is noted that various example embodiments of the power optimization element 111 may be further understood by way of reference at least to FIG. 2, FIG. 3, and FIG. 10.

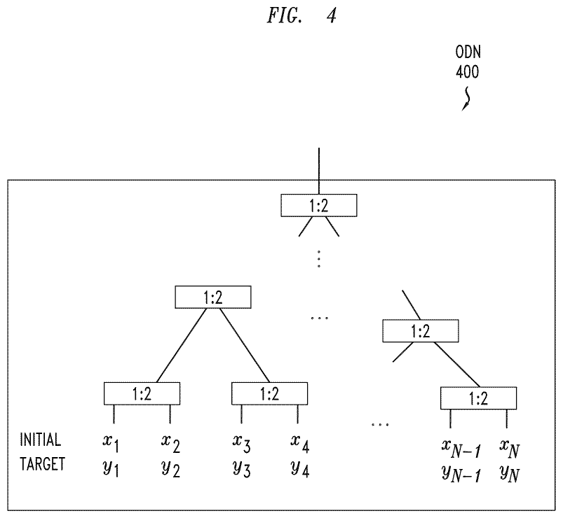

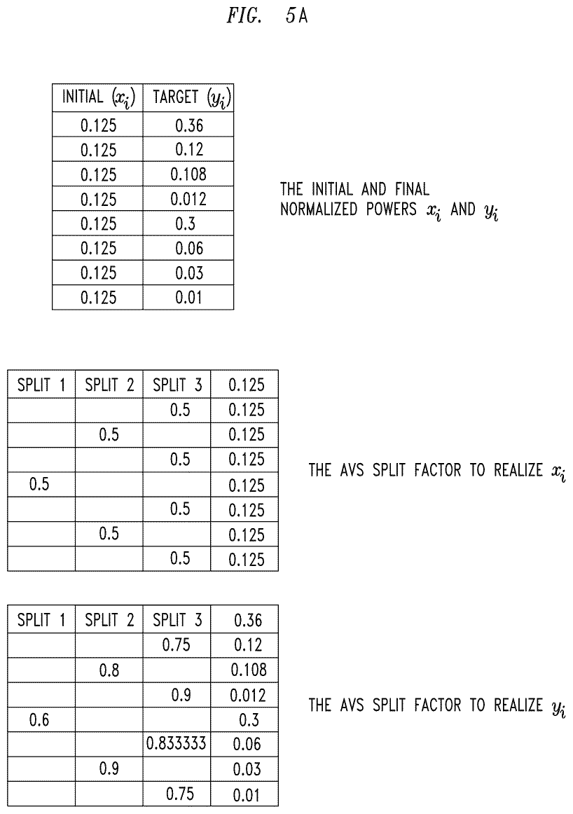

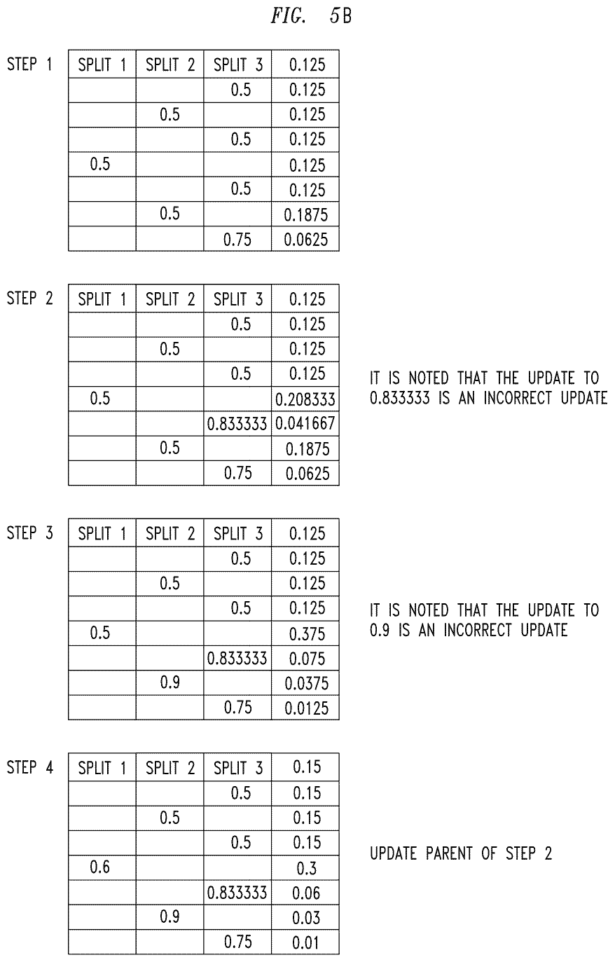

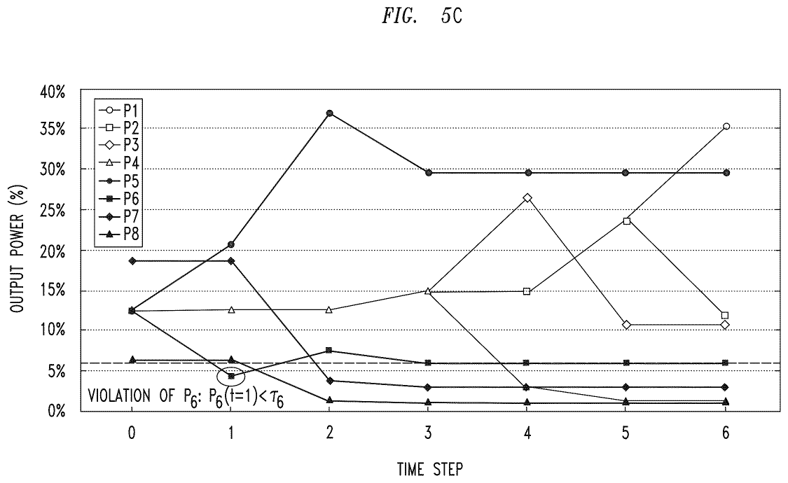

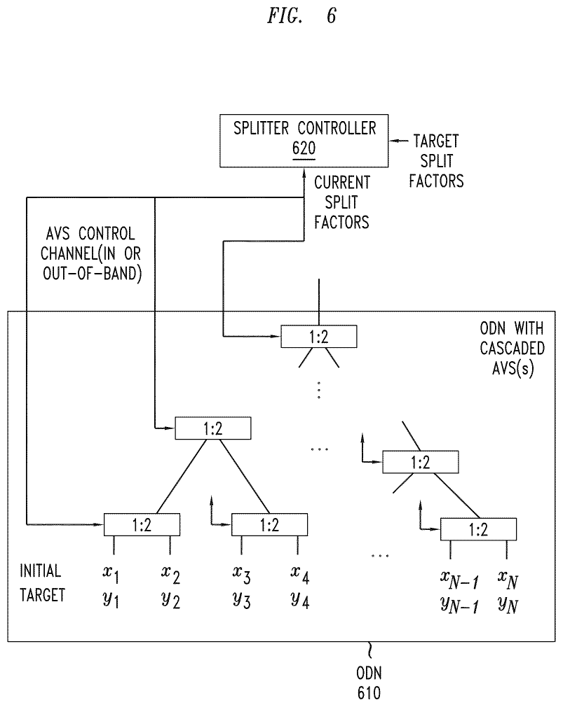

The splitter adjustment element 112, as indicated above, is configured to support reconfiguration of the variable optical splitter 131 to use a target power split ratio for communications from the OLT 110 to the ONUs 120 via the ODN 130. The splitter adjustment element 112 may be configured to determine, for the variable optical splitter 131, a current power split setting for the variable optical splitter 131 and a target power split setting for the variable optical splitter 131 and generate, based on the current power split setting for the variable optical splitter 131 and the target power split setting for the variable optical splitter 131, a sequence of reconfiguration operations for reconfiguration of the variable optical splitter 131 from the current power split setting for the variable optical splitter 131 to the target power split setting for the variable optical splitter 131. It will be appreciated that, although primarily presented with respect to example embodiments in which the splitter adjustment element 112 supports reconfiguration of the variable optical splitter 131 to use a specific type of optical power setting (namely, a target optical power split setting such as a target optical power split ratio), the splitter adjustment element 112 may be configured to support reconfiguration of the variable optical splitter 131 to use various other types of optical power settings. It will be appreciated that, although primarily presented as being disposed within the OLT 110, splitter adjustment element 112 may be disposed in any other suitable location (e.g., as a standalone system within or associated with the PON 100, on a computer configured to be connected to the variable optical splitter 131 or otherwise communicatively interfaced with one or more elements of the PON 100, or the like, as well as various combinations thereof). It is noted that various example embodiments of the splitter adjustment element 112 may be further understood by way of reference at least to FIG. 4, FIGS. 5A-5C, FIG. 6, FIG. 7, FIGS. 8A-8C, FIG. 9, and FIG. 10.

It will be appreciated that the PON 100, although primarily presented as having a specific configuration, may be configured in various other ways.

Various example embodiment may be configured to support optimization of power consumption in a PON based on reconfiguration of a variable optical splitter in the ODN of the PON to support a target optical power split setting, such as a target optical power split ratio. The optimization of power consumption based on reconfiguration of the variable optical splitter may be based on determination of a target optical power split ratio for the variable optical splitter and reconfiguration of the variable optical splitter to use the target optical power split ratio for the variable optical splitter. The determination of the target optical power split ratio for the variable optical splitter may be based on various types of input information associated with the passive optical network (e.g., ONU channel information, ONU receiver characterization information, or the like, as well as various combinations thereof). The optimization of power consumption based on reconfiguration of the variable optical splitter to use the target optical power split ratio for the variable optical splitter may be configured to redirect excess optical power incident on one or more of the ONUs having relatively good channel quality to one or more of the ONUs having relatively bad channel quality such that the overall operation of the ONUs is improved while the overall power consumption of the ONUs is reduced or minimized. It will be appreciated that these example embodiment for optimizing power consumption in a PON may be further understood by first considering various aspects of PONs, and power consumption within PONs, more generally.

PONs provide broadband access using a point-to-multi-point (P2MP) topology in which one OLT at the network side is used to connect to a multitude of ONUs (e.g., up to 64 ONUs, although it will be appreciated that fewer or more ONUs may be supported) at the user side by means of an optical distribution network (ODN) or fiber plant that contains optical fibers and splitters, but generally does not include any active components. Most PON technologies, such as Ethernet PON (E-PON), Gigabit PON (G-PON) and 10 Gigabit Symmetric PON (XGS-PON), are time-division multiplexing (TDM) PON technologies, in which the fiber medium is shared in time between the different ONUs. In the downstream (DS) direction (i.e., OLT to ONUs), the signal is broadcast from the OLT to all of the ONUs. In the upstream (US) direction (i.e., ONUs to OLT), a time-division multiple-access (TDMA) scheme, also known as burst-mode (BM) operation, is employed, in which ONUs sends burst signals that do not overlap in time with bursts from other ONUs. Additionally, time-and-wavelength-division multiplexing (TWDM) PON technologies exist, such as Next Generation PON 2 (NG-PON2), in which multiple TDM/TDMA systems at different wavelengths are stacked on the same PON system. It will be appreciated that various other types of PON technologies exist, are in development, and may continue to be developed in the future.

Low-density parity-check (LDPC) codes are an advanced and popular type of forward-error correction (FEC) code used to correct bit errors that occur during the transmission of data over a physical medium. LDPC codes are used in many contemporary standards for many different types of communications technologies. For example, LDPC codes are often used in WiFi communication technologies (e.g., WiMax), cellular wireless communication technologies (e.g., 5G NR), coaxial cable communication technologies (e.g., DOCSIS 3.1 and DOCSIS 3.1 FDX), digital subscriber line (DSL) communication technologies (e.g., G.mgfast), and powerline communication technologies (e.g., G.hn), among others. An LDPC code is a block code that takes K information bits and encodes these K information bits into a codeword of N bits, which generally includes the K information bits in addition to N−K parity bits (meaning it is a systematic code). The code rate of a LDPC code is R=K/N, and its characteristics are fully described by a (N−K)λN parity check matrix H. In H, the N columns correspond to the bits of the LDPC codeword, with the first K bits corresponding to information (data) bits di and the last (N−K) bits corresponding to the parity bits pᵢ. The N−K rows correspond to the check constraints that any valid codeword of the LDPC code should satisfy, namely that the XOR-sum of all the bits indicated in the row has to be 0. This can be formally expressed as (a sum followed by a modulo-2 operation is equivalent to an XOR-sum): mod(H.c,2)=0, where c is the column vector of the data bits d and the parity bits p.

Contemporary LDPC codes are typically quasi-cyclic (QC) LDPC codes. In QC LDPC codes, the parity check matrix of a QC LDPC code can be subdivided into Z×Z sub-matrices in which each of the sub-matrices is either a rotated identity matrix or an all zero matrix. Here, Z is often called the lifting factor. The parity-check matrix of a QC code can be represented using a compact matrix H_{compact}. Generally, in a compact matrix H_{compact}, a value of −1 indicates an all zero submatrix and any other element m indicates an identity submatrix that has been circularly right shifted by m. The advantage of QC LDPC codes is that QC LDPC codes inherently allow parallelization, which can for instance be seen by the fact that each of the Z check constraints in a row of H_{compact} are the same constraint, but applied to a different set of (independent) bits.

As explained above, an LDPC code is characterized by a code rate R=K/N, that is defined by its parity check matrix (i.e., by its structure). There are, however, two simple techniques that can be used to derive additional LDPC daughter codes from a so-called LPDC mother code: shortening and puncturing. In shortening, the LDPC code can be modified by setting information bits to a fixed value (0), and not transmitting the bits. Shortening Nₛ bits lowers the code rate to R=(K−Nₛ)/(N−Nₛ), and allows achievement of the same output BER at an increased BER value. Thus, a shortened code is more tolerant to errors as compared to the mother code but has a lower code rate. In puncturing, the LDPC can be modified by not transmitting certain bits (either information or parity bits), and these bits are then treated as erasures at the receiver (i.e., bits with unknown value), and have to be retrieved by the LDPC decoder). Puncturing Nₚ bits increases the information rate to R=K/(N−Nₚ), but requires a lower input BER to achieve the same output BER. Thus, a punctured code has a higher code rate as compared to the mother code but is less tolerant to errors. Additionally, by jointly puncturing and shortening, the rate R=(K−Nₛ)/(N−Nₚ−Nₛ) of an LDPC code can be adjusted over a wide range. If, for instance, keeping the code length fixed to N′, the code length can be varied from Rₘᵢₙ=(K−(N−N′))/N′ to Rₘₐₓ=K/N′. It is noted that these techniques of shortening and puncturing are not specific to LDPC codes, but can be generally applied to FEC codes.

LDPC codes are typically decoded using iterative algorithms that pass messages between the variable nodes and check nodes of the bipartite graph of the code, which is an equivalent representation of the parity-check matrix H. The variable nodes correspond to the bits of the codeword while the check nodes correspond to the parity check equations. A variable node vi is connected to a check node ci if the bit di corresponding to vi participates in the parity-check equation corresponding to ci. Decoding begins by initializing the variable nodes with the log-likelihood ratio of the bits received from the channel. Once initialized, the messages are passed from the variable nodes to the check nodes and back over several iterations to progressively refine the estimate of the bits of the codeword. The decoding process is typically continued until a maximum number of iterations is reached. Alternatively, the decoding process may also be terminated if the parity-check matrix is determined to be satisfied at any point in time before the maximum number of iterations has been carried out (called an early exit mechanism).

The ITU-T standardization body has published the G.9804.3 standard for 50G PON. This standard combines a 50G line rate in downstream (DS), with 12.5G and 25G in upstream (US). In February 2023, Amendment 1 of the standard was published, which also includes a 50G US line-rate and additional upstream FEC options. The G.9804.3 physical media dependent specification goes hand-in-hand with the G.9804.2 common transmission convergence layer specification, which specifies aspects related to framing of the data transmission. The forward error correction (FEC) scheme of the G.9804 standard is based on an LDPC mother code with 57*256=14592 information bits and 12*256=3072 parity bits, i.e., a (17664,14592) mother code. In the DS direction, the specified code is derived by puncturing 384 parity bits and no shortening of the mother code. I.e., the DS code is a (17280, 14592) code. The same (17280, 14592) code is also used in the US direction with the additional ability to appropriately shorten the last codeword in a burst. In addition, US transmission with different shortening and puncturing of the (17664, 14592) mother code is also optionally supported by the standard to provide a trade-off between error correcting performance and code rate.

Typical PON ODNs employ a cascaded network of passive optical splitters where each optical splitter has a fixed or predefined splitting ratio (with the passive splitters typically having nominally equal power splitting. Adjustable variable splitters (AVS) have also been considered for deployment in PON ODNs. AVSs, which may also be known by other names such as variable-ratio coupler (VRC), allow for the split factor, and hence the amount of optical power that couples from the input to the output branches of the splitter, to be varied. AVSs may be realized by taking advantage of various physical phenomena such as magneto-optical effects, mechanically strain sensitive couplers, spatial light modulator (SLM) based couplers, field-induced waveguides in liquid crystals, or the like. To configure and assign the split levels, the Intelligent Splitter Monitor (ISM) concept with communication path and remote powering could be used. Alternatively, mechanical set-and-forget splitters, where the splitting ratio may be adjusted by a technician in the field could also be employed. Battery operated powering of the splitters to allow for remote configuration is also possible.

PON ODNs may employ various types, numbers, and arrangements of splitters, including fixed optical splitters and variable optical splitters such as AVSs, to support PONs. AVSs may be used within the context of a flexible PON to improve robustness or throughput of the PON in conjunction with flexible modulation and FEC techniques. The optical splitters may include various types and numbers of optical splitters which may be organized in various topologies (e.g., flat versus hierarchical) to support delivery of optical signals from the OLT to the ONUs. For example, the ODN may include a single 1:64 fixed optical splitter, a 1:16 fixed optical splitter cascaded into four 1:4 fixed optical splitters, N stages of 1:2 fixed optical splitters, a 1:16 fixed optical splitter cascaded into four 1:4 variable optical splitters, a 1:16 variable optical splitter cascaded into four 1:4 variable optical splitters, N stages of 1:2 variable optical splitters, a 1:64 variable optical splitter, or the like. It will be appreciated that, in such architectures using multiple optical splitters, the optical splitters may or may not be physically co-located. It will be appreciated that various other types, numbers, and arrangements of splitters, including fixed optical splitters and variable optical splitters such as AVSs, may be used within ODNs of PONs.

LDPC decoding may cause significant power consumption in a PON. The downstream PON protocol in G.9804, which is derived from previous standards, requires each ONU to decode all of the received downstream FEC codewords to enable satisfactory operation of higher layers of the protocol. As mentioned previously, LDPC decoding is typically carried out using iterative message passing schemes. A key advantage of implementing the early exit mechanism in the decoder is that it can be exploited to reduce dynamic power consumption in the decoder as compared to a decoder that always executes the maximum number of iterations. The power consumed by the LDPC decoder circuitry is non-negligible and constitutes a significant portion of the power consumed by the digital signal processor (DSP) in the ONU. Furthermore, the dynamic power consumption of an LDPC decoder with early-exit is roughly proportional to the average number of iterations required to decode, which in turn is a function of the quality of the communication channel (e.g., described by the bit-error-ratio (BER) or signal-to-noise ratio (SNR) of the channel).

In LDPC decoding, the behavior of the average number of iterations to decode as a function of channel quality defined by the BER at the input to the decoder may provide a number of insights. For example, assuming a binary symmetric channel, use of an (17152, 14592) LDPC code based on the same mother code as used in G.9804 but with 512 bits punctured (which is the LDPC code is used in the 25GS MSA standard for both downstream and upstream), improving the BER from 1e−2 to 1e−3 may reduce the mean iterations to decode from ~5 to ~2. This implies an iteration (and hence dynamic power) reduction by a factor of more than 2 for ~2.5 dB electrical SNR improvement. However, there is a diminishing reduction in average iterations to decode when the BER improves further, since a minimum number of decoder iterations will always be executed to reconstruct the punctured parity bits. Similarly, for example, for the G.9804 default (17280, 14592) code, as well as certain variants used in the upstream direction, improvements in the BER also may reduce the mean iterations to decode. Here, it should be noted that, unlike LDPC codes, the typical decoding complexity of codes previously used in PON standards (such as the Reed Solomon codes) is less dependent on the channel quality, primarily because non-iterative schemes are employed for decoding.

In a PON, downstream reception is wasteful of power since LDPC decoding of all codewords must be carried out by each ONU irrespective of whether that ONU is the intended recipient of data in a codeword. This is especially the case for ONUs close to the sensitivity limit since it will take significantly more iterations, on average, to decode all of the codewords. OLTs and ONUs complying with the G.9804 standard are expected to be deployed at scale in the near future and these deployments are likely to exist in the field for several years after that before being supplanted by the next generation of PON. Changing the downstream FEC protocol to be less wasteful by being more cognizant of intended traffic to ONUs is highly unlikely in the context of G.9804. While such a change may be considered for future PON standards such as G.vhsp (very-high-speed PON) being discussed in the ITU-T, there is no guarantee that such protocol changes will in fact be made. Thus, the wasteful decoder processing of downstream codewords at each of the multitude of ONUs in a PON is an inefficiency that likely will have to be contended with for many years to come.

Various example embodiments may be configured to reduce or even optimize the overall power consumption at all ONUs in an ODN. Various example embodiments may be configured to reduce or even optimize the overall power consumption at the ONUs in an ODN while still adhering to the current downstream protocol defined in PON standards that rely on iterative algorithms for FEC decoding. Various example embodiments may be configured to reduce or even optimize the overall power consumption at the ONUs in an ODN, while still adhering to the current downstream protocol defined in PON standards that rely on iterative algorithms for FEC decoding, by exploiting the presence of AVS in flexible ODNs for the purpose of holistically (i.e., considering all the ONUs in an ODN together) reducing, optimizing, or minimizing the power consumption required for FEC decoding at the ONUs. Various example embodiments may be configured to reduce or even optimize the overall power consumption at the ONUs in an ODN based on a set of techniques configured to modify the optical power split ratio for ONUs connected to an AVS(s) to take excess optical power incident on ONUs with relatively good channel quality (e.g., low pre-FEC BER) and allocate it to provide additional optical power to ONUs with poorer channel quality (i.e., BER near the sensitivity limit) to lower the pre-FEC BER of the ONUs with poorer channel quality, thereby reducing or even optimizing the overall power consumption at the ONUs in the ODN. It will be appreciated that these as well as various other example embodiments may be further understood by way of reference to FIG. 2 and FIG. 3, which are discussed hereinbelow.

FIG. 2 depicts an example embodiment of a PON including a flexible ODN including adjustable variable splitters (AVSs) which may be configured to utilize an optical power split ratio for optimization of power consumption for communications between the OLT and the ONUs of the PON.

The PON 200 includes a set of ONUs 210-1 to 210-N (collectively, 210), an ODN 220, and an OLT 230. The set of ONUs 210 includes F groups of ONUs 210 where each of the F groups of ONUs 210 includes G ONUs 210 (i.e., F*G=N). The ODN 220 includes a set of F adjustable variable splitters (AVSs) 221-1 to 221-F (collectively, AVSs 221) and a fixed splitter 222. The F AVSs 221 are each 1:G AVSs with one branch connecting the AVS 221 to one of the F outputs of the fixed splitter 222 and G branches connecting the AVS 221 to G of the ONUs 210. The fixed splitter 222 is a 1:F splitter with F branches connecting the fixed splitter 222 to the inputs of each of the F AVSs 221, respectively, and with one branch connecting the fixed splitter to the OLT 230. It will be appreciated that the ODN 220 may be configured in various ways as depicted (e.g., the values of G and F may vary based on the number of ONUs 210 to be supported), may be configured in various other ways (e.g., fewer or more AVSs may be used, fewer or more fixed splitters 222 may be used, different arrangements of splitters may be used, different numbers of hierarchical levels may be used, and so forth), or the like, as well as various combinations thereof. The OLT 230 includes an ONU management element 231 and a split optimizer 235. The ONU management element 231 is configured to perform ONU management functions for managing the ONUs 230. The split optimizer 235 is configured to determine an optical power split ratio for the AVSs 221 and configure the AVSs 221 to operate using the optical power split ratio for the AVSs 221, thereby enabling reduction or even optimization of the power consumption of the ONUs 210.

The split optimizer 235 obtains input information associated with the ODN 220 and, based on evaluation of the input information, determines optical power split ratio for the AVSs 221 and configures the AVSs 221 to operate using the optical power split ratio. The input information may include ONU channel information for the ONUs 210, receiver characterization information associated with receivers of the ONUs 210, current optical power split ratio of the AVSs 221, or the like, as well as various combinations thereof. The split optimizer 235 may compute optical power split ratio for the AVSs 221, based on the input information, in various ways. In at least some example embodiments, which also may be referred to herein as Technique 1, the optical power split ratio for the AVS 221 may be determined in a manner for ensuring that pre-FEC BER at all ONUs 210 served by the AVS 221 is at values where the average iterations to decode is as close as possible to a target number T. In at least some example embodiments, which also may be referred to herein as Technique 2, instead of targeting a specific BER corresponding to a fixed number of iterations to decode, the optical power split ratio for the AVS 221 may be determined using a cost function configured to minimize the mean iterations to decode or total decoder power consumed across all ONUs 210 served by the AVS 221. These techniques are described further hereinbelow. It will be appreciated that other techniques may be used for evaluating the input information to compute the optical power split ratio for the AVSs 221.

The split optimizer 235, as indicated above, may obtain ONU channel information for the ONUs 210 for use in computing the optical power split ratio for the AVSs 221. The split optimizer 235 may obtain the ONU channel information for the ONUs 210 from the ONU management element 210, which may obtain the ONU channel information from the ONUs 210. The ONU channel information may include reach information (x), error counters from the ONUs 210, received signal strength indicator (RSSI) values from the ONUs 210, ranging information for the ONUs 210, or the like, as well as various combinations thereof. The split optimizer 235 uses the ONU channel information for the ONUs 210 to compute a downstream channel metric for each of the ONUs 210. For example, the downstream channel metric may be a pre-FEC

BER which may be estimated from the monitoring counters. As an example, based on the monitoring counters supported in G.9804.2, the pre-FEC BER may be estimated as: pre-FEC BER=[number of corrected FEC bits]/[bits_per_codeword*(number of total FEC codewords−number of uncorrectable FEC codewords)]. For example, the downstream channel metric may be a received signal strength metric computed based on RSSI values for the ONUs 210. For example, the downstream channel metric may be distance/reach of the ONUs 210 from the OLT 230, which may be computed based on the ranging information for the ONUs 210. It will be appreciated that various other types of ONU channel information may be obtained, various other types of downstream channel metrics may be computed, or the like, as well as various combinations thereof.

The split optimizer 235, as indicated above, may obtain receiver characterization information associated with receivers of the ONUs 210 for use in computing the optical power split ratio for the AVSs 221. The split optimizer 235 may obtain the receiver characterization information for the ONUs 210 from any suitable source of such receiver characterization information, such as locally from a memory of the OLT 230 and/or from any other suitable source of such information. The receiver characterization information may be a function of the channel metric. For example, the receiver characterization information may be in the form of the behavior of the average decoder power as a function of the channel metric, the average number of iterations needed to decode as a function of the channel metric, or the like as well as various combinations thereof. The channel characterization information may be obtained from an a priori analysis of the decoder implementation and stored in the memory of the OLT 230, may be in the form of different types of penalty versus reach estimates based on ONU receiver modeling and/or testing, or the like, as well as various combinations thereof.

The split optimizer 235, as indicated above, may obtain the current optical power split ratio of the AVSs 221 for use in computing the optical power split ratio for the AVSs 221. The split optimizer 235 may obtain the current power split ratios for the AVSs 221 from an AVS control channel between the OLT 230 and the AVSs 221. It will be appreciated that the split optimizer 235 may obtain the current power split ratios for the AVSs 221 in various other ways.

The split optimizer 235, as indicated above, controls reconfiguration of the AVSs 221 to use the computed optical power split ratio. The split optimizer 235 may communicate the optical power split ratio to the AVSs 221 in various ways. For example, the split optimizer 235 may communicate the optical power split ratio to the AVSs 221 in-band or out-of-band. For example, the split optimizer 235 may communicate the optical power split ratio to the AVSs 221 via the AVS control channel from the split optimizer 235 to the AVSs 221. For example, the split optimizer 235 may communicate the optical power split ratio to the AVSs 221 via the ONU management element 231 in the OLT 230. For example, the split optimizer 235 may communicate the optical power split ratio to the AVSs 221 directly without using the ONU management element 231 in the OLT 230. It will be appreciated that the split optimizer 235 may communicate the optical power split ratio to the AVSs 221 in various other ways. It will be appreciated that the AVSs 221, upon being configured to support the optical power split ratio, apply the optical power split ratio to achieve the desired optical output powers on the branches to the ONUs 210 and, thus, to achieve the desired power consumption by the ONUs 210.

It will be appreciated that the split optimizer 235 may be configured to support various other functions for determining the optical power split ratio for the AVSs 221 and configures the AVSs 221 to operate using the optical power split ratio.

It will be appreciated that, although primarily presented with respect to specific arrangements of the PON 200, various other arrangements of the PON 200 may be supported. For example, although primarily presented with respect to example embodiments in which specific types, numbers, and arrangements of splitters are used within the ODN 220, the ODN 220 may be implemented using various other types, numbers, and/or arrangements of splitters. For example, although primarily presented with respect to example embodiments in which the split optimizer 235 is disposed within the OLT 230, the split optimizer 235 may be disposed within any other suitable element or implemented as a standalone element. It will be appreciated that various other arrangements of the PON 200 may be supported.

The optical power split ratio for an AVS, as indicated above, may be computed in various ways. The optical power split ratio for an AVS may be computed based on various types of input information, evaluation of the input information in various ways, use of various metrics, consideration of various constraints, or the like, as well as various combinations thereof. In at least some example embodiments, which also may be referred to herein as Technique 1, the optical power split ratio for the AVS may be determined in a manner for ensuring that pre-FEC BER at all ONUs served by the AVS is at values where the average iterations to decode is as close as possible to a target number T. For example, based on the example of the (17152, 14592) LDPC code discussed hereinabove, a suitable value of T could be 2, which corresponds to a target pre-FEC BER BER_{T}=1e−3 (although it will be appreciated that various other targets may be used for determination of the optical power split ratio for the AVS). Here, with the appropriate choice of T (and, hence, BER_{T}), the decoder power consumption for all ONUs connected to the AVS can be reduced. In at least some example embodiments, which also may be referred to herein as Technique 2, instead of targeting a specific BER corresponding to a fixed number of iterations to decode, the optical power split ratio for the AVS may be determined using a cost function configured to minimize the mean iterations to decode or total decoder power consumed across all ONUs served by the AVS. Various aspects of these techniques for reducing or optimizing power consumption in a PON based on computation of optical power split ratio(s) for AVS(s) are discussed further below. It will be appreciated that various other techniques may be employed for reducing or optimizing power consumption in a PON based on computation of optical power split ratio(s) for AVS(s).

In at least some example embodiments, which also may be referred to herein as Technique 1, the optical power split ratio for the AVS may be determined in a manner for ensuring that pre-FEC BER at all ONUs served by the AVS is at values where the average iterations to decode is as close as possible to a target number T. Here, it is assumed that the ODN is designed to have a 1:G AVS closest to the ONUs.

In Technique 1, the inputs and outputs are as follows. In Technique 1, for each set of G ONUs, the following inputs are used: (1) reach (distance of the link) and available margin (ODN+TX+Rx) for each of the ONUs assuming equal split (these quantities can be derived from the channel metrics acquired by the split optimizer), (2) target pre-FEC BER B* for reduced average iterations as compared to the reference pre-FEC BER, B_{ref} (e.g., B* can be 1e−3 for B_{ref}=1e−2), (3) penalty vector P as a function of reach x, where P represents the optical penalty for operating at B* at distance×(NRZ (B* @ x)) with respect to operating at B_{ref} at back-to-back. NRZ (B_{ref} @ b2b), and (4) optical path penalty vector OPP as a function of reach x, where OPP represents the optical penalty for operating at B_{ref} at distance×(NRZ (B_{ref} @ x)) with respect to operating at B_{ref} at back-to-back (NRZ (B_{ref} @ b2b)). In Technique 1, the outputs are the computed values of the optical power split ratio for each of the G ONUs and an estimate of the margin with the computed values of the optical power split ratio for each of the G ONUs.

In Technique 1, the procedure for processing the inputs to obtain the outputs is as follows. As an initial step, the ONUs are grouped into three categories as follows: low-power capable, low-power seeking, low-power unsupported (initially empty). Then, the following processing is performed until the seeking list is empty (at which point no further optimization is possible). First, determine the minimum split factor required for ONUs in all three groups. For ONUs in the ‘capable’ list and the ‘seeking’ list, the minimum split is computed based on margin over and above P, whereas for the ‘unsupported list’ the minimum split factor is either kept at 1/G or computed based on margin over and above OPP. It is noted that, during the first pass, already ‘capable’ ONUs will yield a minimum split factor ≤1/G, while ‘seeking’ ONUs will require a split factor of >1/G. The ‘unsupported’ group is empty in the first pass. Second, the following if/else function is applied: if sum of minimum split factors >1 (not all ‘seeking’ ONUs can be made capable) then move ‘seeking’ ONU needing the highest split factor to the unsupported list and returns to the first step to again determine the minimum split factor required for ONUs in all three groups and continue the process, else (all ‘seeking’ ONUs can be made ‘capable’) and the optimal split factor is set to minimum_split_factor/sum (which ensures equal excess margin for all ONUs) and all ONUs in the “seeking” list are moved to the “capable” list. If the “else” branch is taken, then the optimal power split ratio has been determined and the process ends such that the AVS may be configured to support the computed optimal power split ratio. As an example, it has been determined that, for an exemplary ODN with 128 ONUs and fully provisioned with 128 1:2 AVSs (i.e., G=128), the number of ONUs that meet target BER B* can be increased from 86% to 98% when the minimum split factor for ‘unsupported’ ONUs is determined by margin over OPP and to 96% when the ‘unsupported’ ONUs have minimum split factor set to 1/G.

In at least some example embodiments, which also may be referred to herein as Technique 2, instead of targeting a specific BER corresponding to a fixed number of iterations to decode, the optical power split ratio for the AVS may be determined using a cost function configured to minimize the mean iterations to decode or total decoder power consumed across all ONUs served by the AVS. Here, as with Technique 1, it is assumed that the ODN is designed to have a 1:G AVS closest to the ONUs.

In Technique 2, the procedure for processing the inputs to obtain the outputs is as follows. First, ONU channel information is obtained and a pre-FEC BER is computed based on the ONU channel information. The ONU channel information may be obtained by the split optimizer from the ONUs and/or any other suitable source of such ONU channel information. The ONU channel information may include reach information (x) and error counters from ONUs to estimate pre-FEC BER. As an example, based on the monitoring counters supported in G.9804.2, the pre-FEC BER may be estimated as: pre-FEC BER=[number of corrected FEC bits]/[bits_per_codeword*(number of total FEC codewords-number of uncorrectable FEC codewords)]. Second, in conjunction with receiver characterization information in the form of receiver margin versus pre-FEC BER for different reach (M(BER, x)) and average number of iterations versus BER or average power versus BER, the split optimizer determines the optimal split ratios as sᵢ, i=1, . . . . G; as

$$s = arg min {\sum }_{i = 1}^{G} λ ( {s}_{i} , {x}_{i} )$$

under constraints 0≤sₘᵢₙ≤sᵢ≤sₘₐₓ<1;

$${\sum }_{i = 1}^{G} {s}_{i} \leq 1 .$$

In the above, xᵢ denotes the reach of ONUi and λ(.) denotes the cost function that translates the split ratio and reach to the average iterations or average power consumption. The quantities sₘᵢₙ and sₘₐₓ, respectively denote the minimum and maximum split factor that can be configured for the 1:G AVS. This second step may be implemented using an iterative algorithm in which the split factor for the AVS is progressively refined until the optical power split ratio is determined, and then the process ends such that the AVS may be configured to support the computed optimal power split ratio.

FIG. 3 depicts an example embodiment of a method for determining a target optical power split setting, such as a target optical power split ratio, for a set of variable optical splitters. It will be appreciated that, although primarily presented as being performed serially, at least a portion of the functions of the method 300 may be performed contemporaneously or in a different order than as presented with respect to FIG. 3.

At block 301, the method 300 begins.

At block 310, obtain a set of input information associated with a PON including a set of variable optical splitters.

For example, the set of input information associated with the PON may include input information associated with a set of communication devices of the PON. For example, the set of input information associated with the PON may include input information associated with a set of receivers of the PON. For example, the set of input information associated with the PON may include at least one of a range of allowable power split settings, a range of allowable transmitted optical power, a range of allowable received optical power, or a range of allowable optical modulation amplitude. For example, the set of input information associated with the PON may include at least one of a set of transmitted optical power levels associated with a set of transmitters of the passive optical network or a set of current received optical power levels associated with a respective set of receivers of the passive optical network. For example, the set of input information associated with the PON may include a current power split setting for the set of variable optical splitters. It will be appreciated that the set of input information associated with the PON may include various other types of information which may be used for computing the target power split setting for the PON.

For example, as noted above, the set of input information associated with the PON may include input information associated with a set of receivers of the PON. For example, the input information associated with the set of receivers may include, for each of one or more of the receivers, a respective set of channel information for the respective receiver. For example, the respective set of channel information for the respective receiver may include at least one of monitoring information configured for use in deriving a BER value, a received signal strength indicator (RSSI) value, or ranging information indicative of a distance of the receiver from a transmitter serving the receiver. For example, respective set of channel information for the respective receiver comprises at least one of total forward error correction codewords and/or bytes and/or bits, uncorrected forward error correction codewords and/or bytes and/or bits, corrected forward error correction codewords and/or bytes and/or bits, or codeword error ratio (CWER) and/or byte error ratio and/or bit error ratio (BER) values. For example, the input information associated with the set of receivers may include, for each of one or more of the receivers, a respective set of receiver characterization information for the respective receiver. For example, the respective set of receiver characterization information for the respective receiver comprises at least one of an average decoder power of a decoder of the receiver, an average number of iterations to decode as a function of bit error rate, or a reach estimate based on a distance of the receiver from a transmitter serving the receiver.

At block 320, determine, based on the set of input information associated with the PON, a target power split setting for the set of variable optical splitters that is configured to control a power consumption of the PON.

The target power split setting for the set of variable optical splitters, that is configured to control a power consumption of the PON, may be configured to control the power consumption of the PON in various ways for various purposes. For example, the target power split setting may be configured to control at least one of a power consumption of a set of transmitters of the PON or a power consumption of a set of receivers of the PON. For example, the target power split setting may be configured to control at least one of a power consumption of a set of ONUs of the PON or a power consumption of a set of OLTs of the PON. For example, the target power split setting, when configured to control a power consumption of a set of ONUs of the PON, may be determined based on a metric that is based on ONU power consumption at the set of ONUs and signal quality at the set of ONUs. For example, the target power split setting, when configured to control a power consumption of a set of OLTs of the PON, may be determined based on a metric that is based on OLT power consumption at the set of OLTs and burst signal quality at the set of OLTs. For example, the target power split setting for the set of variable optical splitters may be configured to control a power consumption of an OLT of the PON, and the control of the power consumption of the OLT is performed over a set of bursts received at the OLT. For example, the target power split setting for the set of variable optical splitters may be configured to reduce an amount of power consumed by at least one of a receiver subsystem, a decoder subsystem, an equalization subsystem, a symbol detection subsystem, a chromatic dispersion compensation subsystem, a maximum likelihood sequence estimation subsystem, or a transmitter subsystem.

The target power split setting for the set of variable optical splitters, that is configured to control a power consumption of the PON, may be configured to control the power consumption of the PON in various ways for various purposes. For example, the target power split setting for the set of variable optical splitters may be configured to constrain a number of forward error correction (FEC) iterations performed by a set of decoders of a set of receivers of the PON. For example, the target power split setting for the set of variable optical splitters may be configured to constrain a mean number of FEC iterations performed by a set of decoders of a set of receivers of the PON. For example, the target power split setting for the set of variable optical splitters may be configured to constrain the mean number of FEC iterations performed by the set of decoders of the set of receivers such that pre-FEC BER at the receivers satisfies a set of thresholds configured to constrain the mean number of FEC iterations performed by the set of decoders of the set of receivers to satisfy a target number of FEC iterations.

The target power split setting for the set of variable optical splitters, that is configured to control a power consumption of the PON, may include various types of information, may be specified in various ways, or the like, as well as various combinations thereof. For example, the target power split setting may include a vector of numbers which sufficiently characterize relative power at each splitter branch with respect to an input of the set of variable optical splitters. For example, where the set of variable optical splitters includes at least one input branch and N output branches, the target power split setting may be represented by a vector of N values which represent, respectively, relative power ratios between the at least one input branch and each of the N output branches. For example, where the set of variable optical splitters includes at least one input branch and N output branches, the target power split setting may be represented as a vector of N−1 values which represent, respectively, relatively power ratios between one of the N output branches and each of the other remaining N−1 output branches. It will be appreciated that the vector of numbers for an N-way split can be uniquely (‘sufficiently’) characterized by N−1 variables (e.g., as a simple example: a 2-way split can be characterized by a single number, which is a ratio of the powers in each of the two branches of the 2-way split). It will be appreciated that the target power split setting for the set of variable optical splitters may be represented in other ways.

At block 399, the method 300 ends.

It will be appreciated that, although primarily presented as ending for purposes of clarity, the method 300 may include various other functions which may be supported in conjunction with controlling configuration of a set of variable optical splitters to control a power consumption of the PON.

For example, the target power split setting for the set of variable optical splitters may be sent toward the set of variable optical splitters. For example, the target power split setting for the set of variable optical splitters may be sent toward the set of variable optical splitters at least one of in-band via an optical distribution network in which the set of variable optical splitters is disposed or out-of-band via an out-of-band communication channel.

For example, the target power split setting for the set of variable optical splitters may be used to generate a sequence of reconfiguration operations for reconfiguration of the set of variable optical splitters from a current power split setting to the target power split setting and the sequence of reconfiguration operations for reconfiguration of the set of variable optical splitters may then be sent to the variable optical splitters for use by the variable optical splitters to configure themselves to operate using the target power split setting.

For example, the target power split setting for the set of variable optical splitters may be used to determine a set of modified transmitter settings for a set of transmitters considered for power optimization and the set of modified transmitter settings for the set of transmitters may then be sent to the set of transmitters for use by the transmitters to configure themselves to use the modified transmitter settings.

It will be appreciated that the method 300 may include various other functions which may be supported in conjunction with controlling configuration of a set of variable optical splitters to control a power consumption of the PON.

Various example embodiment may be configured to support optimization of power consumption in a PON based on reconfiguration of a variable optical splitter in the ODN of the PON to support a target optical power split setting, such as a target optical power split ratio. The reconfiguration of the variable optical splitter to use the power split ratio may be based on generation of a sequence of reconfiguration operations for reconfiguration of the variable optical splitter to the target optical power split ratio, such that the sequence of reconfiguration operations for reconfiguration of the variable optical splitter may be applied to the reconfigurable optical splitter for reconfiguring the variable optical splitter from the current power split ratio to the target optical power split ratio, in a coordinated manner over time to ensure hitless (e.g., impact-free) operation of the PON as the reconfiguration of the variable optical splitter to the target optical power split ratio is performed (e.g. no optical connection is compromised (stops working) or reinitializes because of the dynamics of the reconfiguration). It will be appreciated that these example embodiment for supporting reconfiguration of the variable optical splitter to use the power split ratio may be further understood by first considering various aspects of AVSs, and operation of AVSs, more generally.

As discussed above, a flexible ODN may be constructed by cascading several stages of individual AVSs (e.g., with a 1:2 split, 1:4 split, or the like)), where the various AVSs of which the different stages are composed may or may not be physically co-located. In such an ODN constructed by cascading multiple individual AVSs, it may be unrealistic to expect all of the AVSs to switch the split-ratio at the same time instant. In such a scenario, it is possible that an uncoordinated update of the different AVSs can lead certain ONUs to experience a temporary reduction in power below their sensitivity limit, which, in turn, can cause them to lose communication with the OLT, i.e., experience a glitch. It is noted that “glitch-free” or “hitless” operation implies that none of the ONUs experience a temporary reduction in power below the sensitivity limit that may cause them to disconnect or lose communication with the OLT. As an example, consider an ODN with N ONUs constructed by cascading log₂(N) stages of 1:2 AVS as shown in FIG. 4.

As illustrated in FIG. 4, an ODN 400 includes a set of cascaded 1:2 AVSs serving N ONUs (with the ONUs being omitted for purposes of clarity). Let the initial normalized powers for the N ONUs be x₁, x₂, . . . , x_{N} and the final normalized powers for the N ONUs be y₁, y₂, . . . , y_{N}, with Σxᵢ=Σyᵢ=1. Hitless operation means that the split factors of the different AVSs are modified in a manner such that the instantaneous normalized power pᵢ at each ONUi never drops below min(xᵢ, yᵢ). A scenario where an ONU may experience a glitch is illustrated in FIGS. 5A-5C, which considers an N=8 ODN with three stages of 1:2 AVSs.

FIGS. 5A-5C depict an example of a scenario in which arbitrary or uncoordinated updates to the optical power split factors of the AVSs of the flexible ODN of FIG. 4 result in a glitch at one of the ONUs served by the set of cascading 1:2 AVSs;

As depicted in FIG. 5A, in such an ODN, there are N−1 separate AVSs arranged in three stages. The initial normalized powers at the ONUs corresponds to an equal split shown by xᵢ, while the target normalized powers are shown by yᵢ. The split factor of the different AVSs corresponding to the initial and target power values are shown in FIG. 5A, which illustrates a 1:8 ODN with initial and final (target) normalized powers, with respective AVS split ratios.

As depicted in FIG. 5B, a naïve approach to update the AVSs may start updating the splitters at the leaf nodes (i.e., connected directly to the ONUs) first and then move up to the next stage, and so on. This is illustrated in FIG. 5B, which depicts the steps of a naïve sequential update of the AVS split factors (illustratively, where the AVS connected to ONUs 7 and 8 is updated first, followed by the AVS connected to ONUs 5 and 6 in the second step, and so forth).

As depicted in FIG. 5C, which illustrates a plot of instantaneous normalized power pᵢ resulting from the naïve sequential update of the AVS split factors in FIG. 5B, the moment that the second leaf AVS is updated, ONU 6 experiences a drop in power that takes it below the minimum of the initial and target normalized powers, thereby leading to a glitch. While this glitch may resolve subsequently after all of the AVSs have been updated, the duration of such a glitch may be long enough to temporarily disrupt service for ONU 6, or even cause it to retrain.

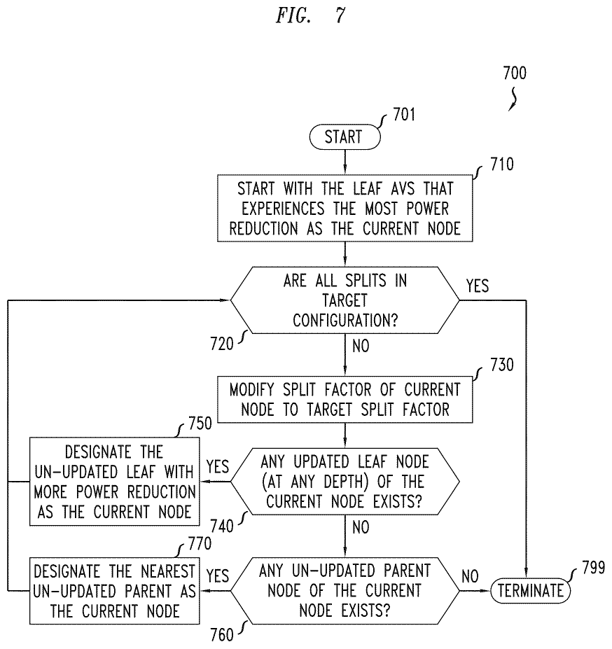

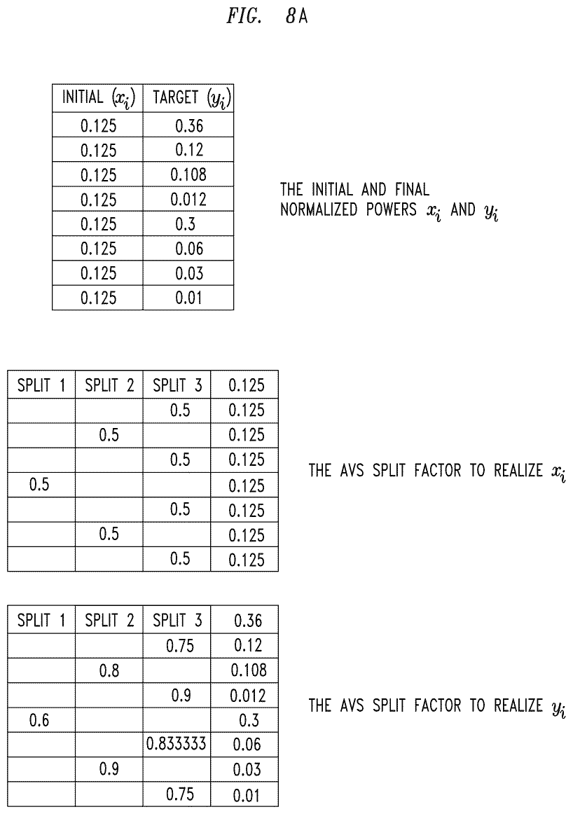

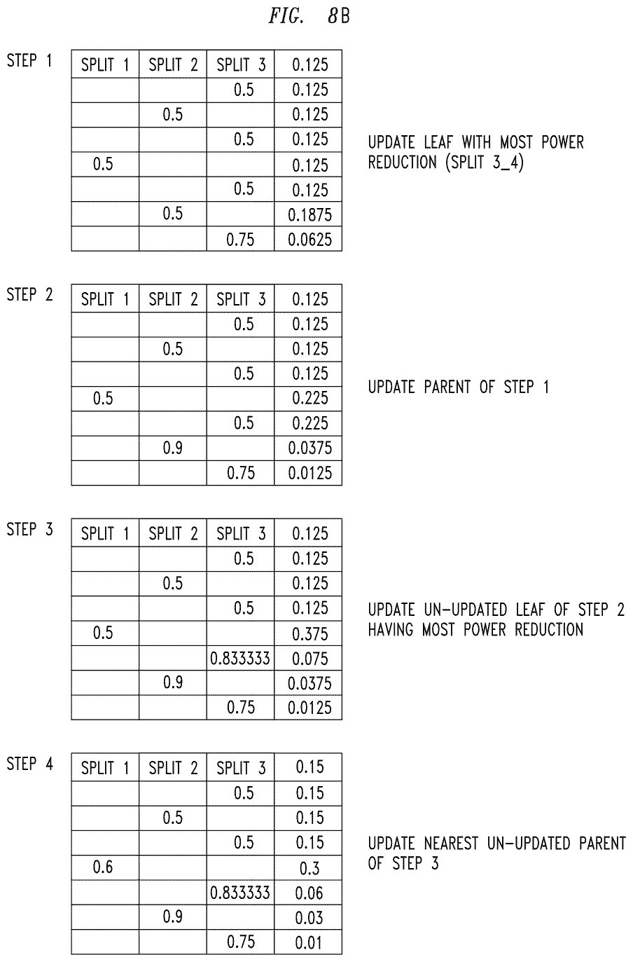

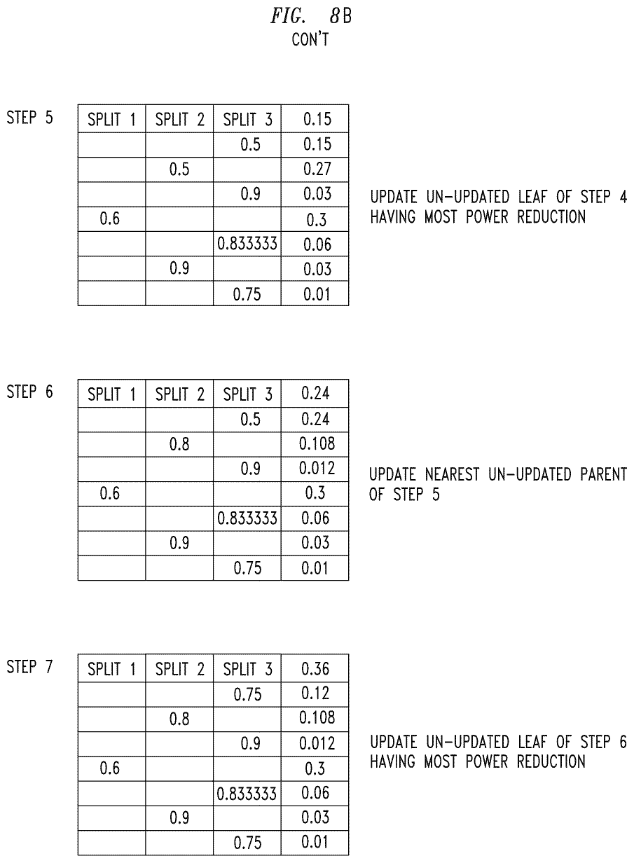

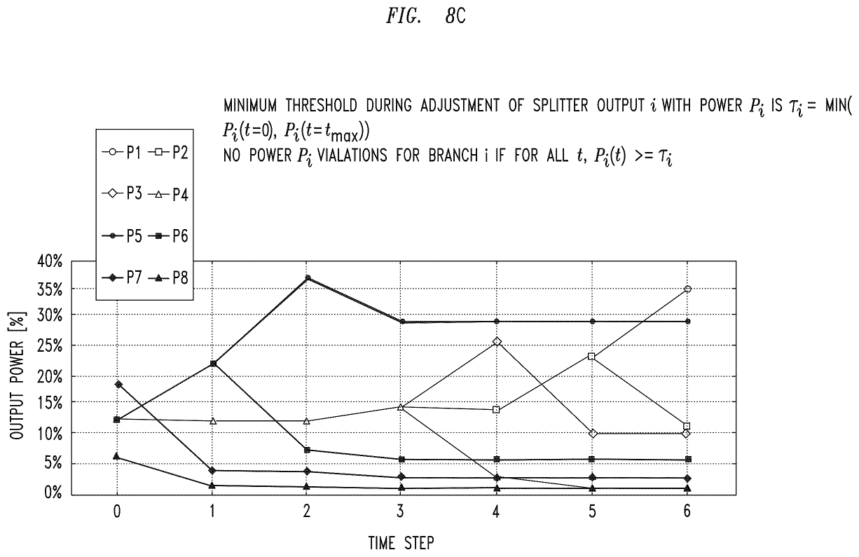

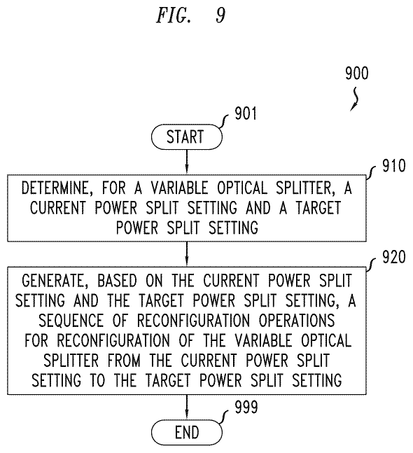

Various example embodiments may be configured to support optimization of power consumption in a PON based on reconfiguration of the ODN of the PON to support a target optical power split setting, such as a target optical power split ratio. The reconfiguration of an ODN of a PON to support a target optical power split ratio may be based on updating the split factors of the AVS(s) of the ODN in a manner that ensures glitch-free or hitless operation of the ONUs served by the AVS(s) of the ODN. The updating of the split factors of the AVS(s) of the ODN based on a target optical power split ratio in a manner that ensures glitch-free or hitless operation of the ONUs served by the AVS(s) of the ODN may be performed by a splitter controller that hosts an algorithm for hitless AVS reconfiguration that is configured to sequentially update the split factors of the AVS(s) over time to ensure glitch-free operation of the ONUs served by the AVS(s) of the ODN. The splitter controller may obtain the current optical power split ratio (e.g., reading the current split factors from the AVS(s), locally from a memory of the splitter controller, from an external source, or the like), obtain the target optical power split ratio (e.g., determine the target optical power split ratio based on example embodiments presented herein, receive an indication of the target optical power split ratio from a source of such information, or the like), determine AVS configuration information for reconfiguring the AVS(s) from supporting the current optical power split ratio to supporting the target optical power split ratio (e.g., a sequence of reconfiguration operations for reconfiguration of the variable optical splitter from the current power split ratio to the target optical power split ratio in a hitless manner, which may include the split factor(s) for the AVS(s), split factor update times(s) at which the split factor(s) are to be updated at the AVS(s), or the like, as well as various combinations thereof). It will be appreciated that these as well as various other example embodiments may be further understood by way of reference to FIG. 6, FIG. 7, FIGS. 8A-8C, and FIG. 9.

FIG. 6 depicts an example of a system including a flexible ODN including a set of cascading 1:2 AVSs configured to serve a set of ONUs and a splitter controller configured to support reconfiguration of the optical power split factors of the AVSs based on a target optical power split ratio for the AVSs.

As illustrated in FIG. 6, the system 600 includes a flexible ODN 610 and a splitter controller 620. The flexible ODN 610 includes several stages of 1:2 AVSs which are cascaded to form a hierarchy of AVSs serving N ONUs (which are omitted for purposes of clarity). The splitter controller 620 is configured to control reconfiguration of AVSs in the flexible ODN 610 in a manner for ensuring glitch-free operation of the ONUs served by the AVS(s) of the flexible ODN 610.

It will be appreciated that, although primarily presented within the context of an ODN with N=24 ONUs constructed with a cascade of (co-located or possible non-co-located) 1:2 AVS, various other configurations of the flexible ODN may be used. For example, the flexible ODN 610 may be generalized to various other cases where the ODN has <2^{L} ONUs (i.e., some AVS are not connected to two ONUs), may be generalized to L stages of 1:K AVSs with N=K^{L} or with a mix of AVSs having different values of K (e.g., one or more 1:2 AVSs, one or more 1:4 AVSs, one or more 1:16 AVSs, or the like), or the like, as well as various combinations thereof.

The splitter controller 620, as indicated above, is configured to control reconfiguration of AVSs in the flexible ODN 610 in a manner for ensuring glitch-free operation of the ONUs served by the AVS(s) of the flexible ODN 610. The splitter controller 620 receives the target optical power split ratio including the target optical power split factors and the current optical power split ratio including the current optical power split factors and controls reconfiguration of the AVSs of the flexible ODN 610 to transition from the current optical power split ratio to the target optical power split ratio. This is represented by letting the initial normalized powers for the N ONUs be x₁, x₂, . . . , x_{N} and the target normalized powers be y₁, y₂, . . . , y_{N}, with Σxᵢ=Σyᵢ=1, and is achieved by, while transitioning from the initial normalized powers xᵢ to the final normalized powers yᵢ, ensuring that the split factors of the different AVS are modified in a manner such that the instantaneous normalized power pᵢ at each ONUi never drops below min(xᵢ, yᵢ), thereby ensuring hitless operation of the ONUs during the reconfiguration of the AVSs from the current optical power split ratio to the target optical power split ratio for communications of the ONUs.

The splitter controller 620, as indicated above, controls reconfiguration of AVSs in the flexible ODN 610, based on the target optical power split ratio including the target optical power split factors and the current optical power split ratio including the current optical power split factors, by controlling reconfiguration of the AVSs of the flexible ODN 610 to transition from the current optical power split ratio to the target optical power split ratio. The current optical power split factors may be received from the AVSs via a control channel, read from memory of splitter controller, received from an external source (e.g., a split optimization module, such as power optimization element 111 or split optimizer 235), or the like, as well as various combinations thereof. The target optical power split factors may be received from an external source (e.g., a split optimization module, such as power optimization element 111 or split optimizer 235). The splitter controller 620, based on the current optical power split factors and the target optical power split factors, generates AVS reconfiguration information for reconfiguring the AVSs, in a hitless manner, from supporting the current optical power split ratio to supporting the target optical power split ratio and initiates reconfiguration of the AVSs, from supporting the current optical power split factors to supporting the target optical power split factors, based on the AVS reconfiguration information.

The splitter controller 620, as indicated above, generates AVS reconfiguration information for reconfiguring the AVSs from supporting the current optical power split ratio to supporting the target optical power split ratio. The AVS reconfiguration information may include the target optical power split factors for the branches of the AVSs and indications of times at which the target optical power split factors for the branches are to be updated at the AVSs to complete the transition from the current optical power split ratio to the target optical power split ratio. The AVS reconfiguration information may be represented as a sequence of steps (e.g., a sequence of update steps where each of the update steps identifies the AVS to be updated in that update step, the target optical power split ratio to be used in that update step, and the time at which the update step is to be executed). It will be appreciated that the AVS reconfiguration information may include various other types of information which may be used to update the AVSs in a hitless manner.

The splitter controller 620, as indicated above, supports reconfiguration of the AVSs, from supporting the current optical power split factors to supporting the target optical power split factors, based on the AVS reconfiguration information (e.g., based on the sequence of steps for updating the AVSs in a hitless manner, where the sequence of update steps may specify the optical power split factors and the times at which the optical power split factors are to be updated at the AVSs). The reconfiguration of the AVSs from supporting the current optical power split factors to supporting the target optical power split factors based on the AVS reconfiguration information may be based on processing of the AVS reconfiguration information to convert the AVS reconfiguration information into internal AVS power split settings which may be further converted by the AVSs into actuator settings which may be used by controllers within the AVSs to reconfigure physical devices (e.g., actuators) within the AVSs that control splitting of optical power between the inputs to the AVSs and the outputs of the AVSs, respectively. The processing of the AVS reconfiguration information to form the internal AVS power split settings may be performed remotely from the AVSs (e.g., the splitter controller 620 processes the AVS reconfiguration information to form the internal AVS power split settings and provides the internal AVS power split settings to the AVSs for use by the controllers at the AVSs to generate the actuator settings that are used to configure the AVSs) or locally at the AVSs (e.g., the splitter controller 620 provides the AVS reconfiguration information to the AVSs and the AVSs process the AVS reconfiguration information to form the internal AVS power split settings for use by the controllers at the AVSs to generate the actuator settings that are used to configure the AVSs).

The AVSs, as indicated above, are configured to obtain internal AVS power split settings and convert the internal AVS power split settings into actuator settings which may be used by controllers within the AVSs to reconfigure the physical devices (e.g., actuators) within the AVSs that control splitting of optical power between the inputs to the AVSs and the outputs of the AVSs, respectively. The AVSs may obtain internal AVS power split settings by generating the internal AVS power split settings locally within the AVSs (e.g., the AVSs receive the AVS reconfiguration information and processors within the AVSs process the AVS reconfiguration information to generate the internal AVS power split settings) or receiving the internal AVS power split settings at the AVSs (e.g., the AVS reconfiguration information is processed remotely from the AVSs and provided to the AVSs, such as by the OLT where the OLT provides the internal AVS power split settings to the AVSs in-band or out-of-band, by a computer which can be physically connected to the AVSs, or the like, as well as various combinations thereof). The physical devices, or actuators, of the AVSs which may be dynamically reconfigured to reconfigure the AVSs from supporting the current power split ratio to supporting the target optical power split ratio may include heaters controlled by current, piezo-electrics controlled by voltage, or the like, as well as various combinations thereof.

It will be appreciated that the system 600, although presented as having a specific configuration, (e.g., including a flexible ODN 610 having specific numbers and arrangements of AVSs), may be configured in various other ways for supporting reconfiguration of AVSs for power optimization in a PON.

The reconfiguration of AVSs based on a target optical power split ratio where the reconfiguration is performed in a manner for achieving hitless operation of the ONUs, as indicated above, may be performed in various ways. In at least some example embodiments, the following algorithm may be performed by a splitter controller to achieve hitless operation of the ONUs. The algorithm begins with the leaf AVS that experiences the most power reduction between initial and final settings as the current node. The algorithm then continues the following procedure until all of the AVSs have been updated based on the target optical power split ratio: (1) modify the optical power split factor of the current node and (2) if any un-updated leaf node of the current node exists, then designate the leaf with most power reduction as the current node; otherwise, designate the nearest un-updated parent as the current node. It is noted that, for the above algorithm, the AVS leaf node with most power reduction is the leaf node that has the largest Σxᵢ−Σyᵢ for all ONUs i connected to it. Alternatively, the largest Σxᵢ/Σyᵢ also may be considered as the metric to quantify the most power reduction. Intuitively, the working of the algorithm may be explained by realizing that the leaf node connected to the ONUs requiring the most power reduction is the safest to update since any intermediate updates of its parents after that will result in intermediate powers at the output of that leaf node to be always higher than the target power. The target power is achieved only when that leaf node and all its parents have been updated. An example embodiment of such an algorithm is presented with respect to FIG. 7.

FIG. 7 depicts an example embodiment of a method for reconfiguring a set of AVSs, based on a target optical power split ratio for the set of AVSs, in a manner for setting the optical power split factors of the set of AVSs to support the target optical power split ratio. It will be appreciated that, although primarily presented as being performed serially, at least a portion of the functions of the method 700 may be performed contemporaneously or in a different order than as presented with respect to FIG. 7.

At block 701, the method 700 begins.

At block 710, start with the leaf AVS that experiences the most power reduction as the current node.

At block 720, a determination is made as to whether all of the optical power splits of the AVSs are in the target configuration. If all of the optical power splits of the AVSs are not in the target configuration, then the method 700 proceeds to block 730, otherwise the method 700 proceeds to block 799 where the method 700 ends.

At block 730, the optical split factor of the current node is modified to the target optical split factor.

At block 740, a determination is made as to whether any un-updated leaf node (at any depth) of the current node exists. If any un-updated leaf node (at any depth) of the current node exists then the method 700 proceeds to block 750, otherwise the method 700 proceeds to block 760.

At block 750, the un-updated leaf node with the most power reduction is designated at the current node, and then the method 700 returns to block 720 to determine whether all of the optical power splits of the AVSs are now in the target configuration.

At block 760, a determination is made as to whether any un-updated parent node of the current node exists. If any un-updated parent node of the current node exists then the method 700 proceeds to block 770, otherwise the method 700 proceeds to block 799 where the method 700 ends.

At block 770, the nearest un-updated parent node is designated at the current node, and then the method 700 returns to block 720 to determine whether all of the optical power splits of the AVSs are now in the target configuration.

At block 799, the method 700 ends.

The utility of this technique is best illustrated with the same example discussed herein with respect to FIGS. 5A-5C, i.e., an ODN having N=8, and, thus, L=3 stages of cascaded 1:2 AVSs, an example of which is provided with respect to FIGS. 8A-8C. Namely, as discussed further below, FIGS. 8A-8C depict details of this example when applying the technique for achieving hitless operation of the ONUs when updating the optical power split ratio of the AVSs.

FIGS. 8A-8C depict an example of a scenario in which intelligent updates to the split factors of the AVSs of the flexible ODN of FIG. 6 prevent glitches in any of the ONUs served by the set of cascading 1:2 AVSs.

As depicted in FIG. 8A, in such an ODN, there are N−1 separate AVSs arranged in three stages. The initial normalized powers at the ONUs corresponds to an equal split shown by xᵢ, while the target normalized powers are shown by yᵢ. The split factor of the different AVSs corresponding to the initial and target power values are shown in FIG. 8A, which illustrates a 1:8 ODN with initial and final (target) normalized powers, with respective AVS split ratios.

As depicted in FIG. 8B, an intelligent approach to update the AVSs (e.g. based on the method of FIG. 7) is illustrated. FIG. 8B shows the application of split ratio setting algorithm in seven steps. At each step, the split factor of an AVS is updated, and the intermediate normalized powers at each ONU resulting from such AVS split factor update also are shown.

In Step 1, the split factor of the leaf AVS with the most power reduction is updated. This is illustrated as an update from a split factor of 0.5 to 0.75, thereby resulting in normalized powers of 0.1875 and 0.0625 at ONU 7 and ONU 8, respectively.

In Step 2, the parent AVS of the leaf AVS updated in Step 1 is updated. This is illustrated as an update from a split factor of 0.5 to 0.9, thereby resulting in normalized powers of 0.225, 0.225, 0.0375, and 0.0125 at ONU 5, ONU 6, ONU 7, and ONU 8, respectively.

In Step 3, the split factor of the un-updated leaf AVS of Step 2 having the most power reduction is updated. This is illustrated as an update from 0.5 to 0.833333, thereby resulting in normalized powers of 0.375, 0.075, 0.0375, and 0.0125 at ONU 5, ONU 6, ONU 7, and ONU 8, respectively.

In Step 4, the split factor of the nearest un-updated parent AVS of Step 3 is updated. This is illustrated as an update from a split factor of 0.5 to 0.6, thereby resulting in normalized powers of 0.15, 0.15, 0.15, 0.15, 0.3, 0.06, 0.03, and 0.01 at ONU 1 through ONU 8, respectively.

In Step 5, the split factor of the un-updated leaf AVS of Step 4 having the most power reduction is updated. This is illustrated as an update from a split factor of 0.5 to 0.9, thereby resulting in normalized powers of 0.15, 0.15, 0.27, 0.03, 0.3, 0.06, 0.03, and 0.01 at ONU 1 through ONU 8, respectively.

In Step 6, the split factor of the nearest un-updated parent AVS of Step 5 is updated. This is illustrated as an update from a split factor of 0.5 to 0.8, thereby resulting in normalized powers of 0.24, 0.24, 0.108, 0.012, 0.3, 0.06, 0.03, and 0.01 at ONU 1 through ONU 8, respectively.

In Step 7, the split factor of the un-updated leaf AVS of Step 6 having the most power reduction is updated. This is illustrated as an update from a split factor of 0.5 to 0.75, thereby resulting in normalized powers of 0.36, 0.12, 0.108, 0.012, 0.3, 0.06, 0.03, and 0.01 at ONU 1 through ONU 8, respectively, which correspond to the target power split ratios yᵢ specified in FIG. 8A.

As depicted in FIG. 8C, the time evolution of the normalized ONU output powers is shown after each step. It is clear from this plot that none of the ONUs experiences a glitch, i.e., pᵢ≥min(xᵢ, yᵢ) at all time steps for all ONUs.

It is noted that it also follows from the example of FIGS. 8A-8C that reversing the steps adequately ensures hitless operation if the normalized powers were to transition from yᵢ to xᵢ. It may be verified that this conforms to the processing steps of the presented algorithm as discussed herein.

FIG. 9 depicts an example embodiment of a method for reconfiguring a variable optical splitter to use a target optical power split ratio. It will be appreciated that, although primarily presented as being performed serially, at least a portion of the functions of the method 900 may be performed contemporaneously or in a different order than as presented with respect to FIG. 9.

At block 901, the method 900 begins.

At block 910, determine, for a variable optical splitter, a current power split setting for the variable optical splitter and a target power split setting for the variable optical splitter. For example, the current power split setting for the variable optical splitter may be determined, or obtained, by accessing the current power split setting locally (e.g., at the OLT where the method is executed by the OLT, at the variable optical splitter where the method is executed at the variable optical splitter, or the like), receiving the current power split setting from a remote device (e.g., receiving the current power split setting at the OLT from the variable optical splitter where the method is executed by the OLT, receiving the current power split setting at a central controller from the OLT or the variable optical splitter where the method is executed by the central control, or the like). For example, the target power split setting for the variable optical splitter may be determined, or obtained, by computing the target power split setting locally (e.g., computing the target power split setting at the OLT or a central controller), by receiving the target power split setting (e.g., receiving the target power split setting at the variable optical splitter from the OLT or a central controller), or the like.

At block 920, generate, based on the current power split setting and the target power split setting, a sequence of reconfiguration operations for reconfiguration of the variable optical splitter from the current power split setting to the target power split setting.

For example, the sequence of reconfiguration operations for reconfiguration of the variable optical splitter from the current power split setting to the target power split setting may be generated by a central device (e.g., the OLT, a central controller, or the like) and provided to the variable optical splitter, may be generated by the variable optical splitter and used at the variable optical splitter for configuration of the variable optical splitter to operate using the target power split setting, or the like.

For example, the sequence of reconfiguration operations for reconfiguration of the variable optical splitter from the current power split setting to the target power split setting may be configured to ensure hitless operation of a set of optical network units served by the variable optical splitter.

For example, where the variable optical splitter is configured to serve a set of optical network units and the target power split setting is indicative of a respective set of final normalized powers for the optical network units, the sequence of reconfiguration operations for reconfiguration of the variable optical splitter from the current power split setting to the target power split setting may be configured to ensure that, for each of the optical network units, a respective instantaneous normalized power at the respective optical network unit remains above a minimum of a respective initial normalized power for the respective optical network unit and the respective final normalized power for the respective optical network unit. For example, the respective set of initial normalized powers for the optical network units may be determined based on the current power split setting or may be determined based on measurement of respective powers on respective branches associated with the optical network units.

For example, where the variable optical splitter is part of a set of variable optical splitters, generating the sequence of reconfiguration operations may include selecting, as a current node, a leaf variable optical splitter whose input power reduces by the largest amount between the initial and final setting of the variable optical splitter, and performing the following procedure until each of the variable optical splitters has been updated: modifying a power split setting of the current node, and, if an un-updated descendant leaf variable optical splitter of the current node exists, designate the leaf variable optical splitter whose input power reduces by the largest amount between the initial and final setting of the set of variable optical splitters as the current node, otherwise designate a nearest un-updated ancestor variable optical splitter of the current node as the current node.

At block 999, the method 900 ends.

It will be appreciated that, although primarily presented as ending for purposes of clarity, the method 900 may include various other functions which may be supported in conjunction with controlling configuration of a variable optical splitter to control a power consumption of the PON.

For example, the sequence of reconfiguration operations for reconfiguration of the variable optical splitter from the current power split setting to the target power split setting may be generated by a central device (e.g., OLT, controller, or the like) and sent from the central device to the variable optical splitter for reconfiguration of the variable optical splitter from the current power split setting to the target power split setting. The variable optical splitter, upon receiving the sequence of reconfiguration operations for reconfiguration of the variable optical splitter from the current power split setting to the target power split setting, may convert the sequence of reconfiguration operations for reconfiguration of the variable optical splitter from the current power split setting to the target power split setting into a set of internal splitter settings for reconfiguration of the variable optical splitter from the current power split setting to the target power split setting and provide the internal splitter settings for reconfiguration of the variable optical splitter from the current power split setting to the target power split setting toward a controller of the variable optical splitter which may use the internal splitter settings for reconfiguring the variable optical splitter from the current power split setting to the target power split setting.

For example, the sequence of reconfiguration operations for reconfiguration of the variable optical splitter from the current power split setting to the target power split setting may be generated by the variable optical splitter for use by the variable optical splitter for reconfiguration of the variable optical splitter from the current power split setting to the target power split setting. The variable optical splitter, upon receiving an indication of the target power split setting, may generate the sequence of reconfiguration operations for reconfiguration of the variable optical splitter from the current power split setting to the target power split setting, convert the sequence of reconfiguration operations for reconfiguration of the variable optical splitter from the current power split setting to the target power split setting into a set of internal splitter settings for reconfiguration of the variable optical splitter from the current power split setting to the target power split setting, and provide the internal splitter settings for reconfiguration of the variable optical splitter from the current power split setting to the target power split setting toward a controller of the variable optical splitter which may use the internal splitter settings for reconfiguring the variable optical splitter from the current power split setting to the target power split setting.

It will be appreciated that, although omitted for purposes of clarity, confirmation of completion of the reconfiguration of the variable optical splitter from the current power split setting to the target power split setting may be supported. For example, since adherence to the sequence of updates is important for hitless reconfiguration, the exchange of information also may include sending an indication that a reconfiguration at the variable optical splitter has been completed (e.g., a message from the variable optical splitter to a device or devices which instructed the variable optical splitter to perform the reconfiguration from the from the current power split setting to the target power split setting).

It will be appreciated that the method 900 may include various other functions which may be supported in conjunction with controlling configuration of a variable optical splitter to control a power consumption of the PON.

Various example embodiment may be configured to support optimization of power consumption in a PON based on reconfiguration of a variable optical splitter in the ODN of the PON to support a target optical power split setting, such as a target optical power split ratio. The optimization of power consumption based on reconfiguration of the variable optical splitter may be based on determination of a target optical power split ratio for the variable optical splitter (e.g., as presented with respect to FIG. 2 and FIG. 3) and reconfiguration of the variable optical splitter to use the target optical power split ratio for the variable optical splitter (e.g., as presented with respect to FIG. 4, FIGS. 5A-5C, FIG. 6, FIG. 7, FIGS. 8A-8C, and FIG. 9). It will be appreciated that, while at least some such example embodiments may be provided separately in order to support optimization of power consumption in a PON, at least some such example embodiments also or alternatively may be provided in combination in order to support optimization of power consumption in a PON. It will be appreciated that a combination of at least some such example embodiments is presented with respect to FIG. 10.

FIG. 10 depicts an example embodiment of a PON configured to support determination of a target optical power split ratio for a variable optical splitter and reconfiguration of the variable optical splitter to use the target optical power split ratio.

The PON 1000 includes an OLT 1010, a computer 1020, and a splitter device 1030. The OLT 1010 includes a power optimization element 1011 that is configured to determine a target optical power split ratio 1012 for the splitter device 1030 and to determine transmitter settings 1013 for a transmitter of the OLT 1010 (which is omitted for purposes of clarity). The OLT 1010 provides the target optical power split ratio 1012 for the splitter device 1030 to the computer 1020. The computer 1020 receives the target optical power split ratio 1012 for the splitter device 1030. The computer 1020 includes a splitter adjustment element 1021 that is configured to support reconfiguration of the splitter device 1030 based on the target optical power split ratio 1012. The splitter adjustment element 1021 processes the target optical power split ratio 1012 to generate splitter reconfiguration information 1022 for the splitter device 1030. The computer 1020 provides the splitter reconfiguration information 1022 for the splitter device 1030. The splitter device 1030 receives the splitter reconfiguration information 1022 for the splitter device 1030. The splitter device 1030 includes a processor 1031, a controller 1035, and a physical splitter device 1039. The processor 1031 processes the splitter reconfiguration information 1022 for the splitter device 1030 to form internal splitter settings 1032 and provides the internal splitter settings 1032 to the controller 1035. The controller 1035 converts the internal splitter settings 1032 into actuator settings 1036 and configures the physical splitter device 1039, based on the actuator settings 1036, to implement the target optical power split ratio 1012 at the splitter device 1030. In this manner, the PON 1000 is configured to support reduced or even optimized power consumption by the set of ONUs (which have been omitted for purposes of clarity) served by the OLT 1010 and the splitter device 1030.

The target optical power split ratio 1012 may be determined based on various inputs, metrics, constraints, or the like, as well as various combinations thereof. For example, the target optical power split ratio 1012 may be determined based on inputs which may originate from a local source(s) and/or a remote source(s), such as from the OLT 1010, the computer 1020, the splitter device 1030, or the like, as well as various combinations thereof. For example, the target optical power split ratio 1012 may be determined based on inputs such as a current optical power split ratio of the splitter device 1030, receiver characteristics of receivers of the ONUs served by the splitter device 1030, or the like, as well as various combinations thereof. For example, the target optical power split ratio 1012 may be determined based on metrics such as power consumption optimization (e.g., related to the LDPC decoders of the ONUs), power optimization due to lower transmit power needed, or the like, as well as various combinations thereof. It will be appreciated that the target optical power split ratio 1012 may be determined based on various other inputs, metrics, constraints, or the like, as well as various combinations thereof.

The power optimization element 1011, as indicated above, may be configured to determine the target optical power split ratio 1012 for the splitter device 1030. The target optical power split ratio 1012 may be determined based on one or more metrics (e.g., based on power consumption of a subsystem versus received or transmitted optical power and versus optical modulation amplitude, and its nonlinear characteristic). Here, the advantage of the nonlinear behavior can be exploited by manipulating the optical power levels and optical modulation amplitudes within the ODN to achieve minimum power consumption based on use of one or more variable optical splitters in the ODN. The target optical power split ratio 1012 may be determined based on consideration of one or more other subsystems with power consumption dependent on the optical power levels, such as transmitter output power (transmit laser or amplifier power consumption), optical modulation amplitude (power consumption of electronic circuits and drivers in the transmitter), or the like, as well as various combinations thereof.

The target optical power split ratio 1012 may be determined in manner for ensuring that the power levels arriving at the ONUs result in a reduction in the mean number of iterations of the LDPC FEC decoders of the ONUs, thereby reducing the power consumption over all ONUs. The target optical power split ratio 1012 may be determined in a manner for exploiting the fact that various ONUs may be equipped with multiple FEC decoder types, with each of the multiple FEC decoder types being applicable to a different range of received optical power levels and exhibiting different power consumption characteristics versus received optical power and versus optical modulation amplitude. Here, other subsystems with power consumption dependent on the optical power levels can also be considered, such as transmitter output power (transmit laser or amplifier power consumption), optical modulation amplitude (power consumption of electronic circuits and drivers in the transmitter), or the like, as well as various combinations thereof.

The target optical power split ratio 1012 may be determined based on a minimum search algorithm. The minimum search algorithm may be configured to attempt to reduce or minimize the overall power consumption by finding a minimum of a model of absolute or relative power consumption of a subsystem or system, including constraints. The minimum search algorithm may be configured to determine the target optical power split ratio 1012 based on the aforementioned characteristics and metrics based on absolute or relative power consumption (e.g., power consumption of all ONUs), with constraints being range of acceptable parameters (e.g., allowable split ratio, transmitted optical power or received optical power or maximum/minimum optical modulation amplitude, or the like, as well as various combinations thereof). The minimum search algorithm may be configured to determine the target optical power split ratio 1012 based on predetermined characteristics (e.g., predetermined power consumption versus received optical power characteristic), inputs collected from the network (e.g., current state of a variable optical splitter or current received optical powers at the receiver inputs of the receivers), or the like, as well as various combinations thereof. The minimum search algorithm may be configured to determine the target optical power split ratio 1012 in various other ways.

The target optical power split ratio 1012 may be determined and represented in various ways. For example, the target optical power split ratio 1012 may be represented by an un-normalized vector of N numbers α_{target}, which characterize relative loss for each optical splitter branch. For example, the target optical power split ratio 1012 may be represented by a vector of N numbers which represent relative power ratios between the input branch and all other branches (e.g., [branch 0: branch 1, branch 0: branch 2, . . . , branch 0: branch N]). For example, the target optical power split ratio 1012 may be a vector of N−1 numbers representing split ratios between one of the output branches and all other output branches (e.g., [branch 1: branch 2, branch 1: branch 3 . . . , branch 1: branch N], [branch 2: branch 1, branch 2: branch 3 . . . , branch 2: branch N], [branch N: branch 1, branch N: branch 2 . . . , branch N: branch N−1], or the like). It will be appreciated that the vector of numbers for an N-way split can be uniquely (‘sufficiently’) characterized by N−1 variables (e.g., as a simple example: a 2-way split can be characterized by a single number, which is a ratio of the powers in each of the two branches of the 2-way split). It will be appreciated that the target optical power split ratio 1012 may be determined and represented in various other ways.

The power optimization element 1011, as indicated above, also may be configured to determine the transmitter settings 1013 for a transmitter of the OLT 1010. The transmitter settings 1013 may include transmitter settings that should be applied to transmitters that were considered for power optimization while determining the target optical power split ratio 1012. For example, the transmitter settings 1013 may include transmitter settings that should be applied to transmitters that were considered for power optimization, such as based on consideration of one or more other subsystems with power consumption dependent on the optical power levels, such as transmitter output power (transmit laser or amplifier power consumption), optical modulation amplitude (power consumption of electronic circuits and drivers in the transmitter), or the like, as well as various combinations thereof. The transmitter settings 1013 may include transmit power, optical modulation amplitude, or the like, as well as various combinations thereof. The transmitter settings 1013 may be determined in various other ways in conjunction with determination of the target optical power split ratio 1012 for power consumption optimization. It will be appreciated that, although omitted for purposes of clarity, the transmitter device can hold a processor which is configured to process the transmitter settings 1013 to apply new internal transmitter settings through a controller of the transmitter device.

The splitter adjustment element 1021, as indicated above, may be configured to process the target optical power split ratio 1012 to generate the splitter reconfiguration information 1022 for the splitter device 1030. The splitter adjustment element 1021 may generate the splitter reconfiguration information 1022 based on a current optical power split ratio that is being utilized at the splitter device 1030 and based on the target optical power split ratio 1012 (e.g., determining a set of reconfiguration steps which may be applied to reconfigure the splitter device 1030 from the current optical power split ratio to the target optical power split ratio 1012. The splitter adjustment element 1021 may generate the splitter reconfiguration information 1022 for the splitter device 1030 based on an algorithm that, using the current optical power split ratio to the target optical power split ratio 1012, generates a sequence of steps which may be executed in order to ensure that during, the reconfiguration of the splitter device 1030, the loss between the branch 0 (OLT side) and branch i (ONU side) will not decrease below min(α_{current,i}, α_{target,i}), where α_{current,i} is the optical loss between branch 0 and i before reconfiguration and α_{target,i} is the optical loss between branch 0 and i after reconfiguration. This ensures that during the reconfiguration process, no optical connection is compromised (stops working) because of the dynamics of the reconfiguration. It will be appreciated that the splitter adjustment element 1021 may be configured to support various other functions configured to support power consumption minimization.

The splitter device 1030, as indicated above, receives the splitter reconfiguration information 1022 for the splitter device 1030, processes the splitter reconfiguration information 1022 for the splitter device 1030 to form the internal splitter settings 1032, converts the internal splitter settings 1032 into the actuator settings 1036, and configures the physical splitter device 1039, based on the actuator settings 1036, to implement the target optical power split ratio 1012 at the splitter device 1030. The processor 1031 processes the splitter reconfiguration information 1022 for the splitter device 1030 to form internal splitter settings 1032. For example, the processor 1031 may translate the target split ratio into internal splitter settings which are dependent on the physical implementation of the physical splitter device 1039 (e.g., a variable optical 1: N splitter). The controller 1035 converts the internal splitter settings 1032 into actuator settings 1036 and configures the physical splitter device 1039, based on the actuator settings 1036, to implement the target optical power split ratio 1012 at the splitter device 1030. For example, the controller 1035 may generate physical signals (e.g., current, voltage, or the like), to drive the actuators of the variable optical splitter and, thus, adjust the splitter. It will be appreciated that the splitter device 1030 may be configured to support various other functions configured to support power consumption minimization.

It will be appreciated that the PON 1000, although presented as having a specific arrangement of elements, may be configured in various other ways while still supporting power consumption optimization. For example, the power optimization element 1011, although primarily presented as being disposed within the OLT 1010, may be implemented in various other ways (e.g., disposed within the computer 1020 or within one or more other suitable elements). For example, the splitter adjustment element 1021, although primarily presented as being disposed within a standalone computer 1020, may be implemented in various other ways (e.g., disposed within the OLT 1010, disposed within the splitter device 1030, disposed within one or more other suitable elements, or the like, as well as various combinations thereof). For example, the processor 1031, although primarily presented as being disposed within the splitter device 1030, may be implemented in various other ways (e.g., disposed within the computer 1020, disposed within the OLT 1010, disposed within one or more other suitable elements, or the like, as well as various combinations thereof. It will be appreciated that the PON 1000 may be implemented using various other arrangements of the elements while still supporting power consumption optimization within the PON 1000.

Various example embodiments for supporting improvement or optimization of power consumption in a PON may provide various advantages or potential advantages. For example, various example embodiments for supporting improvement or optimization of power consumption in a PON may be configured to, in a PON that employs optical splitters, reduce or optimize power consumption in the downstream direction from the OLT to the ONUs, reduce or optimize power consumption in the upstream direction from the ONUs toward the OLT, or jointly reduce or optimize combined power consumption in both upstream and downstream directions. For example, various example embodiments for supporting improvement or optimization of power consumption in a PON may be configured to, in a PON that employs optical splitters along with iterative decoding-based FEC schemes such as LDPC codes, improve or optimize one or more metrics associated with operation of the OLT(s) and/or the ONUs in the downstream direction from the OLT to the ONUs (e.g., reducing or optimizing power consumption of the ONUs in performing LDPC FEC operations within the context of decoding, reducing or optimizing a number of FEC iterations performed by the ONUs, or the like, as well as various combinations thereof), in a manner for improving or optimizing one or more metrics associated with operation of the ONUs and/or the OLT(s) in the upstream direction from the ONUs to the OLT(s) (e.g., reducing or optimizing power consumption of the OLT(s) in performing LDPC FEC operations within the context of decoding, reducing or optimizing a number of FEC iterations performed by the OLT(s), or the like, as well as various combinations thereof), or a combination thereof. It will be appreciated that various example embodiments for supporting improvement or optimization of power consumption in a PON may be configured to provide various other advantages or potential advantages.

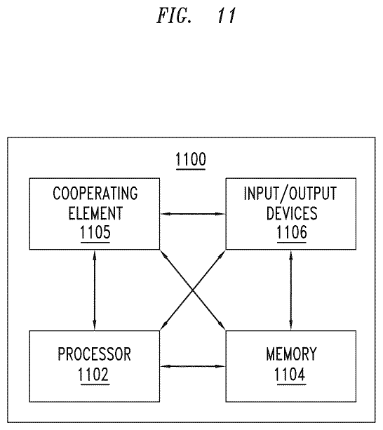

FIG. 11 depicts an example embodiment of a computer suitable for use in performing various functions presented herein.

The computer 1100 includes a processor 1102 and a memory 1104. The processor 1102 may be a processing unit (e.g., a central processing unit (CPU), a graphics processing unit (GPU), or the like) having one or more cores, a core of a processing unit, or the like. The memory 1104 may be a random access memory (RAM), a read-only memory (ROM), or the like. In at least some example embodiments, the computer 1100 may include at least one processor (e.g., processor 1102) and at least one memory (e.g., memory 1104) storing instructions that, when executed by the at least one processor, cause the computer 1100 to perform various functions presented herein.

The computer 1100 also may include a cooperating element 1105. The cooperating element 1105 may be hardware, firmware, software, or various combinations thereof. The cooperating element 1105 may be a process that can be loaded into the memory 1104 and executed by the processor 1102 to implement various functions presented herein (in which case, for example, the cooperating element 1105 (including associated data structures) can be stored on a non-transitory computer readable medium, such as a storage device or other suitable type of storage element (e.g., a magnetic drive, an optical drive, or the like)).

The computer 1100 also may include one or more input/output devices 1106. The input/output devices 1106 may include one or more of a user input device (e.g., a keyboard, a keypad, a mouse, a microphone, a camera, or the like), a user output device (e.g., a display, a speaker, or the like), one or more network communication devices or network communication elements (e.g., an input port, an output port, a receiver, a transmitter, a transceiver, or the like), one or more storage devices (e.g., a tape drive, a floppy drive, a hard disk drive, a solid state drive, or the like), or the like, as well as various combinations thereof.

It will be appreciated that computer 1100 may represent a general architecture and functionality suitable for implementing functional elements described herein, portions of functional elements described herein, or the like, as well as various combinations thereof. For example, the computer 1100 may provide a general architecture and functionality that is suitable for implementing one or more elements presented herein. For example, the computer 800 may provide a general architecture and functionality that is suitable for implementing at least one of an OLT or a portion thereof, an ONU or a portion thereof, an optical communication device or a portion thereof, a computer or a portion thereof, or the like, as well as various combinations thereof.

It will be appreciated that at least some of the functions presented herein may be implemented in software (e.g., via implementation of software on one or more processors, for executing on a general purpose computer (e.g., via execution by one or more processors) so as to provide a special purpose computer, and the like) and/or may be implemented in hardware (e.g., using a general purpose computer, one or more application specific integrated circuits, and/or any other hardware equivalents).

It will be appreciated that at least some of the functions presented herein may be implemented within hardware, for example, as circuitry that cooperates with the processor to perform various functions. Portions of the functions/elements described herein may be implemented as a computer program product wherein computer instructions, when processed by a computer, adapt the operation of the computer such that the methods and/or techniques described herein are invoked or otherwise provided. Instructions for invoking the various methods may be stored in fixed or removable media (e.g., non-transitory computer readable media), transmitted via a data stream in a broadcast or other signal bearing medium, and/or stored within a memory within a computing device operating according to the instructions.

It will be appreciated that, as used herein, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular network device, or other network device or computing device.

It will be appreciated that the term “non-transitory” as used herein is a limitation of the medium itself (i.e., tangible, not a signal) as opposed to a limitation of data storage persistency (e.g., RAM versus ROM).

It will be appreciated that, as used herein, “at least one of <a list of two or more elements>” and “at least one of the following: <a list of two or more elements>” and similar wording, where the list of two or more elements are joined by “and” or “or”, mean at least any one of the elements, or at least any two or more of the elements, or at least all the elements.

It will be appreciated that, as used herein, the term “or” refers to a non-exclusive “or” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

1-20. (canceled)

21. An apparatus, comprising:
at least one processor; and
at least one memory including instructions which, when executed by the at least one processor, cause the apparatus at least to perform:
obtaining a set of input information associated with a passive optical network including a set of variable optical splitters; and
determining, based on the set of input information associated with the passive optical network, a target power split setting for the set of variable optical splitters that is configured to control a power consumption of the passive optical network.

22. The apparatus of claim 21, wherein the target power split setting for the set of variable optical splitters is configured to control at least one of a power consumption of a set of transmitters of the passive optical network or a power consumption of a set of receivers of the passive optical network.

23. The apparatus of claim 21, wherein the target power split setting for the set of variable optical splitters is configured to control at least one of a power consumption of a set of optical network units of the passive optical network or a power consumption of a set of optical line terminals of the passive optical network.

24. The apparatus of claim 21, wherein the target power split setting for the set of variable optical splitters is configured to control a power consumption of a set of optical network units of the passive optical network, wherein the target power split setting is determined based on a metric that is based on optical network unit power consumption at the set of optical network units and signal quality at the set of optical network units.

25. The apparatus of claim 21, wherein the target power split setting for the set of variable optical splitters is configured to control a power consumption of a set of optical line terminals of the passive optical network, wherein the target power split setting is determined based on a metric that is based on optical line terminal power consumption at the set of optical line terminals and burst signal quality at the set of optical line terminals.

26. The apparatus of claim 21, wherein the target power split setting for the set of variable optical splitters is configured to control a power consumption of an optical line terminal of the passive optical network, wherein the control of the power consumption at the optical line terminal is performed over a set of bursts received at the optical line terminal.

27. The apparatus of claim 21, wherein the target power split setting for the set of variable optical splitters is configured to constrain a mean number of forward error correction (FEC) iterations performed by a set of decoders of a set of receivers of the passive optical network such that pre-FEC bit error rate (BER) at the receivers satisfies a set of thresholds configured to constrain the mean number of FEC iterations performed by the set of decoders of the set of receivers to satisfy a target number of FEC iterations.

28. The apparatus of claim 21, wherein the target power split setting for the set of variable optical splitters is configured to reduce an amount of power consumed by at least one of a receiver subsystem, a decoder subsystem, an equalization subsystem, a symbol detection subsystem, a chromatic dispersion compensation subsystem, a maximum likelihood sequence estimation subsystem, or a transmitter subsystem.

29. The apparatus of claim 21, wherein the input information associated with the set of receivers comprises, for each of one or more receivers in a set of receivers of the passive optical network, at least one of a respective set of channel information for the respective receiver or a respective set of receiver characterization information for the respective receiver.

30. The apparatus of claim 29, wherein the respective set of channel information for the respective receiver comprises at least one of:
monitoring information configured for use in deriving a bit error rate (BER) value, a received signal strength indicator (RSSI) value, or ranging information indicative of a distance of the receiver from a transmitter serving the receiver; or
total forward error correction codewords and/or bytes and/or bits, uncorrected forward error correction codewords and/or bytes and/or bits, corrected forward error correction codewords and/or bytes and/or bits, or codeword error ratio (CWER) and/or byte error ratio and/or bit error ratio (BER) values.

31. The apparatus of claim 29, wherein the respective set of receiver characterization information for the respective receiver comprises at least one of an average decoder power of a decoder of the receiver, an average number of iterations to decode as a function of bit error rate, or a reach estimate based on a distance of the receiver from a transmitter serving the receiver.

32. The apparatus of claim 21, wherein the set of input information associated with the passive optical network comprises at least one of a range of allowable power split settings, a range of allowable transmitted optical power, a range of allowable received optical power, or a range of allowable optical modulation amplitude.

33. The apparatus of claim 21, wherein the set of input information associated with the passive optical network comprises at least one of a set of transmitted optical power levels associated with a set of transmitters of the passive optical network or a set of current received optical power levels associated with a respective set of receivers of the passive optical network.

34. The apparatus of claim 21, wherein the set of input information associated with the passive optical network comprises a current power split setting for the set of variable optical splitters.

35. The apparatus of claim 21, wherein the target power split setting comprises a vector of numbers which sufficiently characterize the target power split setting for the set of variable optical splitters.

36. The apparatus of claim 21, wherein the instructions, when executed by the at least one processor, cause the apparatus at least to perform:
sending, toward the set of variable optical splitters, the target power split setting for the set of variable optical splitters.

37. The apparatus of claim 36, wherein the instructions, when executed by the at least one processor, cause the apparatus at least to perform:
receiving, at the set of variable optical splitters, the target power split setting for the set of variable optical splitters;
determining, at the set of variable optical splitters, a current power split setting for the set of variable optical splitters;
generating, at the set of variable optical splitters based on the current power split setting for the set of variable optical splitters and the target power split setting for the set of variable optical splitters, a sequence of reconfiguration operations for reconfiguration of the set of variable optical splitters from the current power split setting to the target power split setting; and
converting, at the set of variable optical splitters, the sequence of reconfiguration operations for reconfiguration of the set of variable optical splitters from the current power split setting to the target power split setting into a set of internal splitter settings for reconfiguration of the set of variable optical splitters from the current power split setting to the target power split setting.

38. The apparatus of claim 21, wherein the instructions, when executed by the at least one processor, cause the apparatus at least to perform:
determining a current power split setting for the set of variable optical splitters;
generating, based on the current power split setting for the set of variable optical splitters and the target power split setting for the set of variable optical splitters, a sequence of reconfiguration operations for reconfiguration of the set of variable optical splitters from the current power split setting to the target power split setting; and
sending, toward the set of variable optical splitters, the sequence of reconfiguration operations for reconfiguration of the set of variable optical splitters from the current power split setting to the target power split setting.

39. The apparatus of claim 38, wherein the instructions, when executed by the at least one processor, cause the apparatus at least to perform:
receiving, at the set of variable optical splitters, the sequence of reconfiguration operations for reconfiguration of the set of variable optical splitters from the current power split setting to the target power split setting; and
converting, at the set of variable optical splitters, the sequence of reconfiguration operations for reconfiguration of the set of variable optical splitters from the current power split setting to the target power split setting into a set of internal splitter settings for reconfiguration of the set of variable optical splitters from the current power split setting to the target power split setting.

40. An apparatus, comprising:
at least one processor; and
at least one memory including instructions which, when executed by the at least one processor, cause the apparatus at least to perform:
determining, for a variable optical splitter, a current power split setting and a target power split setting; and
generating, based on the current power split setting and the target power split setting, a sequence of reconfiguration operations for reconfiguration of the variable optical splitter from the current power split setting to the target power split setting.
